(19) United States
(12) Patent Application Publication
(10) Pub. No.: US 2025/0153174 A1
(43) Pub. Date: May 15, 2025

(54) A METHOD FOR ACOUSTIC CONTROL OF PARTICLES

(71) Applicant: UNIVERSITY OF BRISTOL, Bristol (GB)

(72) Inventors: Luke COX, Bristol (GB); Bruce DRINKWATER, Bristol (GB); Anthony CROXFORD, Bristol (GB)

(21) Appl. No.: 18/840,065

(22) PCT Filed: Feb. 17, 2023
(86) PCT No.: PCT/GB2023/050363

§ 371 Date: Aug. 20, 2024

(30) Foreign Application Priority Data
Feb. 21, 2022 (GB) 2202329.5

(51) Int. Cl. B01L 3/00; G10K 15/02

(52) U.S. Cl. CPC B01L 3/502761; B01L 3/50273; G10K 15/02; B01L 2400/0436

(57) ABSTRACT

A method is provided for acoustic control of particles in a space. The method includes providing particles in the space, wherein the particles are in an initial state; selecting a desired state of the particles in the space to be achieved through control of the particles; and selectively creating different acoustic force fields to obtain the desired state of particles by changing the phase, frequency and/or amplitude of the acoustic waves and controlling the time each of the different acoustic force fields is applied for so that at least a portion of the particles move in a desired way in the space from the initial state to the desired.

### FIELD

The present invention relates to methods, and apparatus, for the acoustic control of particles.

### BACKGROUND

There is a need to manipulate and control objects, particularly small objects such as microscale objects, i.e. objects which have dimensions in the micrometre range e.g. between 0.1 and 100 μm in size or diameter, or objects that are up to 3 mm in size or diameter.

For example, in the biological sciences, there is interest in manipulating and/or patterning biological cells (which are generally microparticles), clusters of cells, organoids or spheriods in order to create structures from them to perform biological functions. This can permit more realistic in-vitro tissues to be achieved in relation to the grafting of biological materials.

Prior art techniques for manipulation of individual cells include the use of so-called optical tweezers. However, optical tweezers are more suited to precise manipulation of individual cells rather than creating larger scale patterns. Other techniques include the use of magnetic fields but they often require either extremely high strength magnetic fields or the use of magnetic particles to label individual cells.

One prior art technique is the use of acoustic fields, in particular, ultrasonic acoustic fields that have been used in manufacturing applications to create smart materials and to pattern hydrogels through patterning particles for manufacturing on their own, or as part of a composite material.

Particular methodologies utilising acoustic fields include imitating an optical tweezer, e.g. through a vortex trap which has a pressure distribution approximately shaped like a first order Bessel function of the first kind having a high pressure ring that traps a particle in its centre and then moving the ring together with the particle. This has been done to manipulate individual particles or cells to move them to a desired location one particle or cell at a time. However this technique is not suited to larger scale patterning of particles or cells because it would require individually moving the particles consuming large amounts of time and having to create a very large number of vortex traps.

Other methodologies utilising acoustic fields generally focus on using a single acoustic pressure field to force particles into a desired spatial/locational pattern. A general arrangement for this purpose utilises a phased array of independent ultrasonic transducers each of which can be electronically controlled to adjust the phase and/or amplitude of the acoustic waves the respective transducer produces. Having a greater number of ultrasonic transducers permits a greater complexity of desired spatial/locational pattern to be achieved. Simulations of such phased arrays indicate promising results but experimental implementations are far less impressive and have only been able to produce simple lines or dots. It is also more complicated and costly to increase to large numbers of ultrasonic transducers. In this respect, so called acoustic holograms have been used to address this issue and utilise a 3D surface, generally 3D printed, to introduce delays to the phase from each ultrasonic transducer effectively creating a phased array having thousands of elements but at low cost.

However, the use of acoustic holograms is inherently inflexible because each desired spatial/locational pattern or image requires a corresponding individually printed acoustic hologram. To address this, so called holographic microbubble arrays have been devised which utilise an array of electrodes to generate bubbles across a grid where the acoustic wave should be stopped. Although these permit complex spatial/locational patterns, e.g. letters, to be created and are dynamically reconfigurable in that different spatial/locational patterns can be created, they suffer from poor contrast and there is a long reset time between each state meaning that although a particular pattern may be changed through a reset process, it does not permit manipulation.

### BRIEF DESCRIPTION OF THE INVENTION

According to an aspect of the present disclosure, there is described a method for acoustic control of particles in a space, the method including:
providing particles in the space, wherein the particles are in an initial state;
selecting a desired state of the particles in the space to be achieved through control of the particles; and,
selectively creating different acoustic force fields to obtain the desired state of particles by changing the phase, frequency and/or amplitude of the acoustic waves and controlling the time each of the different acoustic force fields is applied for so that at least a portion of the particles move in a desired way in the space from the initial state to the desired state which involves performing two or all of the following steps:
a) switching between selected different acoustic force fields to create a low force impulse control mode in which low force impulses are exerted on the particles and the acoustic force field exerted on the particles is effectively the sum of the selected different acoustic force fields so that the particles move to an intermediate state prior to another step being performed, or move to the desired state;
b) switching between selected different acoustic force fields to create a high force impulse control mode in which high force impulses are exerted on the particles so the particles reach the equilibrium point(s) of the acoustic force field that is present by the time the next acoustic force field is applied so that the particles move to an intermediate state prior to another step being performed, or move to the desired state; and
c) switching between selected different acoustic force fields to create an intermediate force impulse control mode in which intermediate force impulses are exerted so that the particles move further towards the equilibrium point(s) of the acoustic force field that is present than in the low force impulse control mode without reaching them by the time next acoustic force field is applied so that the particles move to an intermediate state prior to another step being performed, or move to the desired state.

According to another aspect of the present disclosure, there is described a method for acoustic control of particles in a space, the method including:
providing particles in the space, wherein the particles are in an initial state which is a two-dimensional or three-dimensional state;
selecting a desired state of the particles in the space to be achieved through control of the particles and which is a two-dimensional state or three-dimensional state; and,
selectively creating different acoustic force fields to obtain the desired state of particles by changing the phase, frequency and/or amplitude of the acoustic waves and controlling the time each of the different acoustic force fields is applied for so that at least a portion of the particles move in a desired way in the space from the initial state to the desired state which involves performing the following step of:
a) switching between selected different acoustic force fields to create a low force impulse control mode in which low force impulses are exerted on the particles and the acoustic force field exerted on the particles is effectively the sum of the selected different acoustic force fields so that the particles move to an intermediate state prior to another step being performed, or move to the desired state; and may include one or more of the steps:
b) switching between selected different acoustic force fields to create a high force impulse control mode in which high force impulses are exerted on the particles so the particles reach the equilibrium point(s) of the acoustic force field that is present by the time the next acoustic force field is applied so that the particles move to an intermediate state prior to another step being performed, or move to the desired state; and
c) switching between selected different acoustic force fields to create an intermediate force impulse control mode in which intermediate force impulses are exerted so that the particles move further towards the equilibrium point(s) of the acoustic force field that is present than in the low force impulse control mode without reaching them by the time next acoustic force field is applied so that the particles move to an intermediate state prior to another step being performed, or move to the desired state.

Optionally or preferably the steps a), b) and/or c) are performed in a pre-determined sequence to arrive at the desired state and/or the initial and desired states correspond to different spatial distributions of the particles.

Optionally or preferably the steps a), b) and/or c) are performed in a sequence for which, after at least one, or after each, step is performed, the state of the particles is determined and, based on the determined state of the particles, a suitable one of the steps a), b) and/or c) is selected to obtain the desired state.

Optionally or preferably one or more of the steps a), b) and/or c) are repeated over a number of cycles before another one of the steps a), b) and c) are performed.

Optionally or preferably one or more sequences of the steps a), b) and/or c) are repeated over a number of cycles, optionally or preferably before a different one or more sequences of the steps a), b) and/or c) are repeated.

Optionally or preferably for step a), the different acoustic force fields include an acoustic force field defining a localisation region for localising at least a portion of the particles and/or orientation of the particles.

Optionally or preferably the different acoustic force fields include a plurality of acoustic force fields defining respective localisation regions, and wherein each localisation region is for localising at least a portion of the particles, and wherein the localisation regions are spaced apart from each other.

Optionally or preferably the different acoustic force fields are switched between as part of step a).

Optionally or preferably the localisation regions are positioned along a pre-determined pattern or shape and the changed state of the particles corresponds to the pre-determined pattern or shape.

Optionally or preferably the pre-determined pattern or shape includes one or more lines and/or optionally or preferably the localisation regions form a continuous region.

Optionally or preferably the one or more lines may include a straight line and/or an arcuate line.

Optionally or preferably the pre-determined pattern or shape is a two dimensional or a three dimensional pattern/shape.

Optionally or preferably the plurality of acoustic force fields include one or more sets of acoustic force fields, each set defining respective localisation regions positioned along a respective pre-determined pattern or shape.

Optionally or preferably step a) includes switching between the acoustic force fields of the one or more sets of acoustic force fields in a pre-defined sequence to effect movement of one or more portions of the particles from a first pre-determined pattern or shape to a second pre-determined pattern or shape.

Optionally or preferably the localisation region(s) may be formed by the acoustic force field(s) defining a twin trap(s) each having respective first and second high pressure regions which define localisation region(s) therebetween, optionally or preferably the twin trap(s) are formed by the acoustic force field(s) being Bessel functions of the first kind with a phase offset to transform them into twin traps and/or optionally or preferably the acoustic force field(s) include one or more further Bessel functions of the first kind whose high pressure regions are positioned near the localisation region(s) to assist in defining the localisation region(s), and/or optionally or preferably the localisation region(s) are formed as part of step a).

Optionally or preferably the acoustic force fields are formed as Bessel functions and the localisation region(s) are formed between high pressure rings surrounding the respective focus points of the Bessel functions.

Optionally or preferably the localisation region(s) may be formed by the acoustic force fields being formed as vortex traps each having respective centres which define the localisation region(s) therebetween.

Optionally or preferably the localisation region(s) may be formed by first and second acoustic force fields forming nth order and mth order Bessel functions of the first kind, where m≥n+1, each having respective high pressure rings surrounding respective centres of the Bessel functions and which define the localisation region(s) therebetween.

Optionally or preferably for step b) the selected different acoustic force fields include two or more acoustic force fields formed from standing waves having different phases, and includes switching between respective ones of the two or more acoustic force fields iteratively in a cycle in the high force impulse control mode so that the particles reach the equilibrium points of the acoustic force field that is present by the time the next one of the two or more acoustic force fields is applied, optionally or preferably this is completed after step a) has been performed to reinforce a pre-determined shape or line created by step a).

Optionally or preferably the switching between respective ones of the two or more acoustic force fields is repeated until all or a substantial number of the particles have been moved to a remote part of the space.

Optionally or preferably for step b), the different acoustic force fields include two or more acoustic force fields formed from n^{th} order Bessel functions of the first kind having respective focus points surrounded by respective high pressure rings and includes switching between respective ones of the two or more acoustic force fields from higher to lower n^{th} order Bessel functions of the first kind iteratively so that the particles move away from the high pressure ring towards the focus point and towards the equilibrium point(s) of the acoustic force field that is present by the time the next one of the two or more acoustic force fields is applied such that the particles agglomerate in a localised, e.g. central, region/area of the space.

Optionally or preferably for step b), the different acoustic force fields include two or more acoustic force fields formed from n^{th} order Bessel functions of the first kind and the method includes switching between respective ones of the two or more acoustic force fields from lower to higher n^{th} order Bessel functions iteratively so that the particles move away from the focus point towards the equilibrium point(s) of the acoustic force field that is present by the time the next one of the two or more acoustic force fields is applied such that the particles move away from the focus point towards a remote area/region of the space.

Optionally or preferably for step c), the different acoustic force fields include two or more acoustic force fields formed from Bessel functions having respective focus points that form a line and includes switching between respective ones of the two or more acoustic force fields iteratively so that the particles move away from the focus points towards the equilibrium points of the acoustic force field that is present by the time the next one of the two or more acoustic force fields is applied such that a localised area/region of the space around the line is cleared of particles.

Optionally or preferably the method steps include using an acoustic hologram, wherein the acoustic hologram may define one or more constituent parts of the desired/intermediate state of particles.

According to another aspect of the present disclosure, there is described an apparatus for performing the method of the above described aspects, the apparatus including:
acoustic wave generators for producing respective acoustic waves which combine to create the different acoustic force fields; and
a control device for controlling the acoustic wave generators to create the different acoustic force fields, wherein the control device is operable to change the frequency, phase and/or amplitude of the acoustic waves produced by each of the acoustic wave generators in order to create the different acoustic force fields, and to control the time each of the different acoustic force fields is applied for; and
wherein the control device is configured to control the acoustic wave generators to switch between the different acoustic force fields.

Optionally or preferably the space includes a fluid in which the particles are contained.

Optionally or preferably the fluid is a stationary liquid and/or may include non-fluid materials, e.g. a solid or quasi-solid structure. For example, the fluid may be a gel material.

Optionally or preferably the apparatus includes a housing which defines a space and a surface on which the particles are positioned and/or move. Optionally or preferably, the housing may be a sterile container, for example, a Petri dish.

Optionally or preferably the acoustic wave generators are arranged in an array that at least partially or completely surrounds the space and the acoustic wave generators face inwardly towards the space, optionally or preferably, to form a 2-D or 3-D array.

Optionally or preferably the array is annular, optionally or preferably, a circle, a polygon and/or flat.

Optionally or preferably the apparatus includes an acoustic hologram, wherein the acoustic hologram may define one or more constituent parts of the desired/intermediate state of particles.

Optionally or preferably the particles are microparticles and/or the acoustic waves are ultrasonic acoustic waves, optionally or preferably the particles are solid, liquid or gas bubbles.

According to another aspect of the present disclosure there is described a method of calibrating an apparatus for performing a method for acoustic control of particles in a space, the apparatus including:
acoustic wave generators for producing respective acoustic waves which combine to create the different acoustic force fields; and
a control device for controlling the acoustic wave generators to create the different acoustic force fields, wherein the control device is operable to change the phase and/or amplitude of the acoustic waves produced by each of the acoustic wave generators in order to create the different acoustic force fields, and to control the time each of the different acoustic force fields is applied for; and
wherein the control device is configured to control the acoustic wave generators to switch between the different acoustic force fields to exert force impulses on a particle, wherein the method of calibrating the apparatus includes:
d) selecting a pre-determined acoustic force field to be created to control movement of a particle in the space;
e) applying the pre-determined acoustic force field to hold the particle in a desired position in the space;
f) altering the pre-determined acoustic force field that is created to exert a force impulse for moving the particle along a path for a first set of acoustic wave generator time applied and maximum amplitude settings;
g) observing movement of the particle to determine the type of force impulse that has been applied to the particle;
h) using steps f) and g) to calibrate the control device in controlling the acoustic wave generators to obtain the desired force impulse to be applied on the particles to acoustically control the particles.

Optionally or preferably step g) involves determining whether the type of force impulse is a low force impulse, a high force impulse, an intermediate force impulse or whether a minimum force has been achieved to move the particle from a stationary state.

Optionally or preferably the method is repeated for further one or more sets of acoustic wave generator applied time and maximum amplitude settings, wherein one of the applied time or amplitude settings is increased/decreased for each repetition to determine for which settings the particle moves in accordance with a different one of a low force impulse control mode, an intermediate force impulse control mode, and a high force impulse control mode.

Optionally or preferably the pre-determined acoustic force field is formed as a trap.

Optionally or preferably the pre-determined acoustic force field is formed as a trap for holding the particles in a localisation region.

Optionally or preferably the trap is formed from a vortex trap, optionally or preferably formed by an acoustic force field created by a first order Bessel function of the first kind.

Optionally or preferably the pre-determined acoustic force field is a standing wave.

Optionally or preferably the method includes:
performing calibration for a plurality of pre-determined acoustic fields, optionally or preferably pre-determined acoustic fields of different orders; and/or
performing calibration for pre-determined acoustic field formed as a twin trap and step f) includes moving the particle in opposite directions along the path.

Optionally or preferably the calibration is performed for different regions or areas of the space.

Optionally or preferably the set of acoustic wave generator time applied and maximum amplitude settings are used to calibrate the control device in controlling the acoustic wave generators to obtain the desired acoustic control of the particles.

Optionally or preferably the method is for calibrating the apparatus to perform a method of acoustic control of multiple particles in the space dependent on the position of each particle in the space, wherein
step d) includes selecting a pre-determined acoustic force field to be created to control movement of multiple particles in the space;
step e) includes applying the pre-determined acoustic force field to hold some or all of the particles in desired starting positions in the space;
step f) includes altering the pre-determined acoustic force field that is created to exert a force impulse for moving some or all of the particles along a path for a first set of acoustic wave generator time applied and maximum amplitude settings;
step g) includes observing movement of the particles to determine the type of force impulse that has been applied to each particle at each starting position; and
step h) includes using steps f) and g) above to calibrate the control device in controlling the acoustic wave generators to obtain the desired force impulse to be applied on the particles at each position to acoustically control the particles.

Optionally or preferably step e) includes the desired starting positions being selected so that the force impulse applied to particles at the selected desired starting positions can be determined.

Optionally or preferably the method is repeated with step e) including the desired starting positions in the space being random so that the particles are arranged in a random spatial distribution, wherein repetition of the method permits the force impulse applied to particles at selected positions to be determined.

Optionally or preferably step g) includes observing the motion of the particles as they move and determining any spatial dependence of the type of force impulse that has been applied to the particles, optionally or preferably a radial dependence of the force impulse.

Optionally or preferably the desired control of the particles includes only moving a portion of the particles and rest of the particles remain stationary.

Optionally or preferably the pre-determined acoustic field is formed as a vortex trap, optionally or preferably formed by an acoustic force field created by a Bessel function and step f) involves altering the pre-determined acoustic field so that only the particles held in the trap move and the rest of the particles remain stationary.

Optionally or preferably a method of acoustically controlling particles in a space according to any preceding aspect includes calibrating an apparatus using a calibration method according to any preceding aspect and calibrating the control device accordingly prior to performing the method to acoustically control the particles.

Optionally or preferably the method includes:
performing a step a), b) and/or c) based on the determined calibration so that particles at different positions in the space experience different ones of the respective force impulse control modes a), b) and/or c); or
performing a step a), b) and/or c) based on the determined calibration so that only a single particle, or portion of the particles are moved by the applied force impulse control mode depending on the position(s) of the particle(s) as determined by the calibration method.

Optionally or preferably the method of any preceding aspect is a computer implemented method or the control device includes receiving instructions to perform the method which are stored on a computer readable medium.

According to another aspect of the present disclosure there is described a computer readable medium on which are stored instructions to perform the method of any preceding aspect.

### BRIEF DESCRIPTION OF THE FIGURES

In order that the present disclosure may be more readily understood, preferable embodiments thereof will now be described, by way of example only, with reference to the accompanying drawings, in which:

FIGS. 1a and 1b are schematic drawings of a prior art apparatus for use with example methods embodying the present disclosure;

FIG. 2a is a schematic drawing of a prior art apparatus with particular settings colour coded and an acoustic pressure field shown therein;

FIG. 2b is an enlarged view of the acoustic pressure field shown in FIG. 2a;

FIGS. 3(a) to (c) are plots of pressure, force of certain acoustic force fields and the range of particle motion at different maximum force impulses when said acoustic force fields are applied respectively;

FIG. 4 is a schematic drawing of an apparatus according to examples embodying the present disclosure;

FIGS. 5(a) to (c) are various force field plots, and simulated particle positions according to examples embodying the present disclosure;

FIG. 6 is a schematic drawing showing a particular arrangement of acoustic force field traps according to examples embodying the present disclosure;

FIGS. 7(a) to (c) are a force field plot, an image obtained from an experiment and a further image obtained from an experiment according to examples embodying the present disclosure;

FIG. 8 is a table of various method tools and associated information related thereto according to examples embodying the present disclosure;

FIGS. 9(a) to (g) are respective images and annotated images obtained from an experiment according to examples embodying the present disclosure;

FIGS. 10(a) and (b) are respective annotated images obtained from experiments according to examples embodying the present disclosure;

FIGS. 11(a) to (d) are respective annotated images obtained from experiments according to examples embodying the present disclosure;

FIGS. 12(a) to (f) are respective annotated images obtained from experiments according to examples embodying the present disclosure;

FIGS. 13(a) to (c) are plots obtained from simulations according to examples embodying the present disclosure; and

FIG. 14 is a table containing results obtained by performing a method according to examples embodying the present disclosure.

Referring to the figures, these will be referenced as appropriate in the following description of examples embodying the present disclosure. Throughout the following description and the rest of the present disclosure, references to particles includes singular particles, groups of particles that may be connected such that they move or behave as a singular object, or biological cells or materials. The term particles also encompasses liquid forms, solid forms, living or inanimate forms, and bubbles.

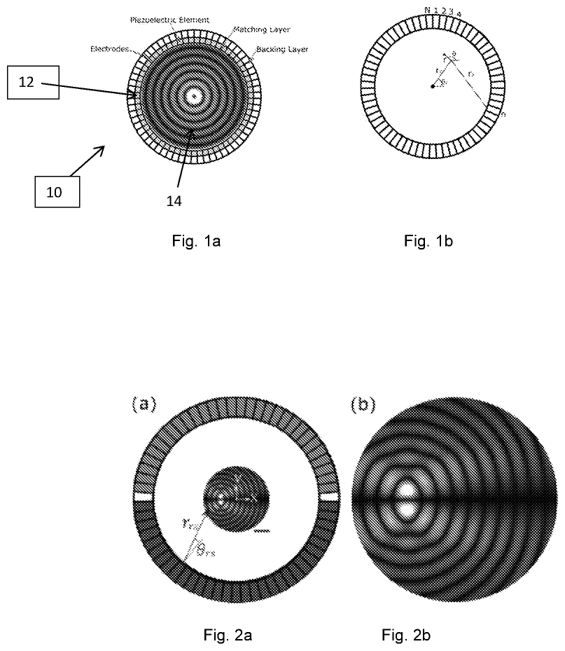

Before describing the examples in detail, it is instructive to describe the theoretical underpinnings thereof. This will be done with reference to a prior art apparatus described in [01]. FIGS. 1a and 1b are schematic figures of the apparatus.

Referring to FIG. 1a, this shows an apparatus 10 including a circular array of acoustic wave generators 12, in this example, transducers in the form of piezoelectric elements with respective control electrodes, capable of generating ultrasonic acoustic waves. Each acoustic wave generator 12 is connected to a control device (not shown) operable to control each acoustic wave generator 12 to create respective acoustic waves and to change the phase, amplitude of the acoustic waves and time they are applied for. The acoustic wave generators 12 are set within a housing (not shown) that includes a central space 14 which is sealed and filled with liquid with microparticles suspended in the liquid. In examples, the central space 14 may not be sealed and, instead, the central space 14 is an open space rather than a closed or sealed space. Each acoustic wave generator 12 faces inwardly towards the space 14 and a backing layer surrounds the acoustic wave generators 12 to absorb and prevent any reflected acoustic waves re-entering the space 14. There are 64 acoustic wave generators in total and the space is 10.98 mm in diameter. It should be noted that the methodology of examples according to the present disclosure is not taught in and the paper is merely an example apparatus which may be utilised as an acoustic generator device to perform the examples.

### Modelling a Particle in Time

First, the behaviour of the particles over time in an acoustic force field/acoustic pressure field created by the apparatus 10 is considered.

2D Huygens' principle models can be used to predict the acoustic pressure field and, if the particles are small with respect to the wavelength λ, e.g. a particle dimension of λ/7, the Gor'kov potential can be used to calculate the acoustic radiation force acting on the particles in the apparatus 10. In this modelling, all particles have a positive acoustic contrast meaning that they move to the low-pressure nodes of the acoustic pressure field/low pressure nodes of the associated acoustic force field.

With reference to FIGS. 2a and 2b, these show the acoustic pressure field in the space as simulated by the model simulating the control device operating the acoustic wave generators 12 to form a twin trap, here created through Bessel function shaped acoustic pressure fields whose phase is spatially inverted within the space. The acoustic pressure field is shown in the centre of the space in FIG. 2a and spans a region of 4 mm in diameter in the centre, and is further shown in enlarged view in FIG. 2b. The colours/shading indicate the phase offset which is necessary to transform the Bessel function shaped acoustic pressure field into a twin trap. The acoustic wave generators 12 in red (top half of the generators 12) and those in blue (bottom half of the generators 12) have a phase difference of π and the generators 12 shown in white are turned off. Although the space 14 is 10.98 mm in diameter, the present modelling only focuses on the central 4 mm as it is in this region that the acoustic pressure field is coherent and in this region that the particles are manipulated. The twin trap is offset from the centre with respect to the x-axis.

Complex pressure fields, p are calculated via matrix propagation, e.g. see [02], from a vector of the complex sources a₀ as in equation (2.1) produced below. The transfer matrix from the external sources to the receiving points in the central region where patterning will take place, Hᵣₛ, is calculated by (2.2) produced below—where ρ₀ is the fluid density, k is the wave number, a is the acoustic wave generator width and λ is the wavelength. The distance rᵣₛ and angle from normal θᵣₛ between the source and receiver are illustrated in FIG. 2a. The apparatus 10 has an absorbent backing so reflections are not considered for the purpose of this modelling.

$$p = {H}_{rs} {a}_{0} \qquad ( 2.1 )$$

$${H}_{r s} = {ρ}_{0} \frac{{e}^{− k {r}_{r s}}}{2 π \sqrt{{r}_{r s}}} sin c ( \frac{{π}^{2} a sin ( {θ}_{r s} )}{λ} ) \qquad ( 2.2 )$$

By way of background, Bessel function shaped acoustic pressure fields will be discussed here in the context of how they can be formed by the apparatus to form a trap. Further details can be found in [01].

Referring to FIG. 1b, this schematically shows the apparatus 10 as having N total acoustic wave generators. For the nth acoustic wave generator, in order to generate a Bessel function of order m at distance rₙ, defined as the distance from the desired trap centre to the n^{th} acoustic wave generator, the phase at the acoustic wave generator n is determined by equation (2.3) produced below.

$${ϕ}_{n} = ( \frac{2 m π ( n − 1 )}{N} − {kr}_{n} ) \qquad ( 2.3 )$$

In order to generate a twin trap in the space 14 of the apparatus 10, a 0th order Bessel function should be formed (i.e. m=0 in equation (2.3) to set the phase of the respective acoustic wave generators). This creates a focusing effect in the space.

To generate a twin trap at a desired location the input phases required to generate a 0th order Bessel function are calculated via equation (2.3), creating the focusing effect. Alongside this a set of input phases are generated to create the cancellation effect by offsetting the phase of half the transducers from the other half by π. To ensure the cleanest cancellation line down the centre those along the axis of the twin trap are set to zero amplitude. This is shown in FIG. 2a by the first colour (red) and second colour (blue) acoustic wave generators elements representing those offset by π and the non-coloured acoustic wave generators are representing those which have been turned off. The set of input phases for the 0th order Bessel function and the twin trap are then added together to produce the phase inputs required to generate a twin trap in the desired location (determined by the Bessel function phases) and orientation (determined by the twin trap phases).

An explanation of how a particle in the space 14 behaves under the acoustic force field produced by the acoustic wave generators 12 will now be provided.

The location of a particle at time t is defined by a vector xₜ. This is calculated iteratively with a sufficiently small time step Δt such that the effective force, Fₑ, and velocity, \dot{x}ₜ can be considered constant. Applying Newton's second law and double integrating the acceleration gives the location after each time step in accordance with equation (2.4) produced below.

$${x}_{t + Δ t} = {\int }_{t}^{t + Δ t} {\int }_{t}^{t + Δ t} \frac{{F}_{e} ( x , \dot{x} )}{{m}_{v}} dtdt = {x}_{t} + {\dot{x}}_{t} Δ t + \frac{{F}_{e} ( x , \dot{x} ) Δ {t}^{2}}{{m}_{v}} \qquad ( 2.4 )$$

To account for entrained flow, a virtual mass, mᵥ, is calculated by equation (2.5) below, where rₚ is the particle radius, ρₚ is the particle density and ρ₀ is the density of the liquid in the space 14, is considered (see [03]).

$${m}_{v} = \frac{4}{3} π {r}_{p}^{3} ( {ρ}_{p} + \frac{ρ 0}{2} ) \qquad ( 2.5 )$$

It is assumed that the force balance is dominated by the acoustic force, F_{ac}, and the drag force, F_{d}, meaning it is defined by equation (2.6) below. This assumption is explored in detail later.

$${F}_{e} = {F}_{ac} ( x ) - {F}_{d} ( \dot{x} ) \qquad ( 2.6 )$$

The acoustic force field for a given pressure field is calculated by the gradient of the Gor'kov potential [4,5] as is shown in equation (2.7) produced below, where U^{rad} is the Gor'kov potential. The derivation is discussed in detail in the prior art literature so here only the parameters used for the case where the liquid is water are stated: c₀=1500 m/s and ρ₀=997 kg/m³ and for the particle cₚ=2047 m/s and ρₚ=1050 kg/m³.

$${F}_{ac} = - ∇ {U}^{rad} \qquad ( 2.7 )$$

The drag force is calculated based on the drag coefficient by equation (2.8) produced below.

$${F}_{d} = \frac{π {r}_{p}^{2} {ρ}_{0} {\dot{x}}_{t} {C}_{d}}{2} \qquad ( 2.8 )$$

The coefficient of drag is given by equation (2.9) [6] produced below, where Rₑ is the Reynolds number.

$${C}_{d} = ( \frac{24}{R e} ) {( 1 + \frac{3}{16} \vert Re \vert )}^{0.5} \qquad ( 2.9 )$$

For the purpose of modelling, it is assumed that the acoustic and drag forces dominate the forces acting on the particles during operation of the apparatus 10 and it is later shown that this gives good agreement with experimental results.

However, it is worth briefly discussing the neglected forces where one is modelling the forces using the Gor'kov potential. Acoustic streaming forces become dominant for extremely small particles but where the assumptions underlying the Gor'kov potential are met (generally λ/7), and Rₑ<100, they can be ignored as not being a significant factor in these calculations [07]. However, it will be appreciated that other approaches may be validly applied to predict the acoustic force field that would impact the particles. For example, finite element model analysis.

### Impulse Response

Using the model above which permits time based behavior of a particle in an acoustic force field to be simulated, it is possible to explore the impact of force impulse on the behavior of the particles as well.

The force impulse experienced by a particle is defined as the force on a particle over a given time. If each acoustic state q, i.e. each given acoustic force field created by the acoustic waves of the acoustic wave generators combining together is denoted as an acoustic state q, has an effective force F_{e,q}(x) exerted for time Δt_{q}, the force impulse on a particle in this field I_{q} is given by equation (2.10) produced below.

$${I}_{q} = {\int }_{0}^{Δ {t}_{q}} {F}_{e , q} ( x ) dt \qquad ( 2.1 )$$

However, for the purpose of modelling particle behaviour, it is more useful to consider the implications of the force impulse exerted rather than the force impulse experienced as the exerted force impulse relates directly to the control parameters of the apparatus 10, i.e. the acoustic force field generated and the time it is applied for. In this case, consider the maximum force impulse possible to understand this impact on the behaviour. This is given by equation (2.11) produced below.

$${I}_{max , q} = max ( {F}_{ac , q} ) Δ {t}_{q} \qquad ( 2.11 )$$

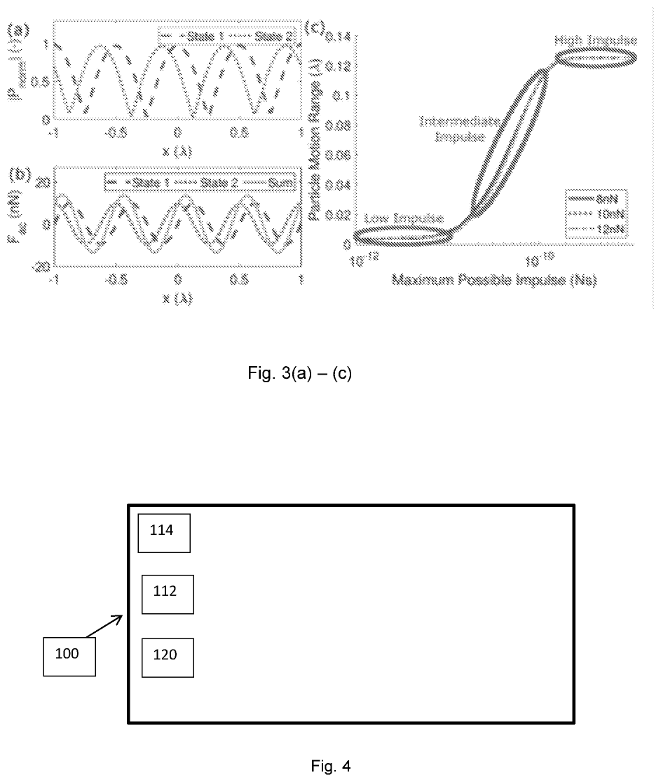

To understand how a particle moves as this force impulse is changed, consider applying the model above to a simple 1D field with two different standing acoustic wave pressure fields, as shown in FIG. 3a. There is a phase shift of π/2 between each of these two acoustic force/pressure fields resulting in respective first and second standing waves with pressure nodes offset by λ/4. The acoustic forces produced by the fields of each of these states are shown in FIG. 3b. FIG. 3b also includes a plot of the sum of these two acoustic force fields for reasons which will be explained.

Now consider placing a particle into this model and the acoustic states, i.e. the acoustic force fields, are switched between using a step change of varying time. In other words, the amount of time each of the acoustic force fields is applied for is varied during the switching. Different magnitudes of acoustic force field are also simulated. The range of the particle's motion over the entire simulation is plotted on the y-axis of FIG. 3c (that is range (xₜ)). The x-axis plots the maximum possible force impulse, defined by (2.11). The force impulse is varied in two ways, changing Δt_{q} from 0.1 ms to 100 ms and by varying the maxima of the acoustic force fields from each of states to one of three values: 8, 10 or 12 nN (with the rest of the respective acoustic force field varying proportionally). Each force value is represented by a different line.

The following represents inventive insights that underpin the methodology of the present disclosure.

At the right hand side of FIG. 3c the particle oscillates between the stable equilibria/equilibrium points of each of the two acoustic states/acoustic force fields. However, at the left hand side the range of motion of the particle is low. This indicates that the particle remains close to the equilibrium points of the sum of the two acoustic force fields, having initially been placed close to this equilibrium.

There are two other points to note in relation to FIG. 3c. The first is that the particle's motion is dependent on the force impulse, not just the force or the time applied for. This is clear as the lines for each force collapse to one when plotted against the force impulse here. The second is the three distinct regimes of particle behaviour, which, for the purpose of the present disclosure, are referred to as low, intermediate and high force impulse control modes.

The high force impulse control mode, at the far right of FIG. 3c, is where the acoustic force field is applied and the particle moves to the equilibrium points of that acoustic force field. When the acoustic force field is changed to the next acoustic force field, the particle now moves to the equilibrium points of the new acoustic force field. The particles thus only moves backwards and forwards as the acoustic force fields are switched in this situation but this mechanism has been used to move particles longer distances.

In the low force impulse control mode shown on the left hand side of FIG. 3c, the particle begins to move towards the new equilibrium points of the next applied acoustic force field each time the acoustic force fields are switched but the particle never reaches the equilibrium points. In control modes that the switching time is small enough relative to the (force dependent) particle response time then the particle instead remains at the stable equilibrium points of the net acoustic force field, i.e. the sum of the first and second acoustic force fields. The location of these equilibrium points will depend on the relative magnitude of the acoustic force fields employed and the time for which they are applied.

It is therefore possible to calculate a vector force field, F_{Q}, which will predict the stable equilibrium points of a set of Q applied fields. At each point, this field, F_{Q}, will be defined by the sum of the acoustic force fields F_{ac,q} weighted by the time they are applied for Δt_{q}. Normalising the acoustic force field by the total time it is applied allows one to calculate F_{Q} by equation (2.12) produced below.

$${F}_{Q} = \frac{{\sum }_{q = 1}^{Q} {F}_{ac , q} Δ {t}_{q}}{{\sum }_{q = 1}^{Q} Δ {t}_{q}} \qquad ( 2.12 )$$

In the intermediate force impulse control mode, the particles move a distance but do not reach the equilibrium points and so this control mode permits the particles to be moved over short distances.

The above modelling and novel insights made by the inventors of the present disclosure will be referenced in the following description of examples of the present disclosure. They also provide the theoretical underpinnings to permit implementation of the present invention in a manner that will be readily appreciated by the skilled person.

### DETAILED DESCRIPTION OF THE DISCLOSURE

With reference to FIG. 4, methods for acoustic control of particles in space in accordance with examples of the present disclosure will be described in relation to an apparatus 100 sharing features in common with the apparatus 10 shown in FIG. 1a. It will be appreciated that the apparatus 100 may vary from the apparatus 10, for example, it may have different types of acoustic wave generators. For example, the acoustic wave generators may be inter-digital transducers (IDTs) which produce surface acoustic waves which can be manipulated themselves or transformed into the acoustic waves, alternatively electromagnetic sources such as magnets and coils akin to audible sound speakers, or capacitive micromachined ultrasonic transducers (CMUTs) may be used. These could operate at different frequencies/wavelengths and/or only act on a small region of the space within the apparatus 100. In examples, the apparatus 100 may have acoustic wave generators arranged in a different shape, e.g. to form a square or other polygon shape, the space may be formed differently and/or the acoustic wave generators may extend about 3D dimensions to permit particle control in 3D dimensions.

The apparatus 100 in all examples will include or define a space 114 in which the particles to be controlled are positioned. The apparatus 100 includes acoustic wave generators 112 for producing respective acoustic waves which combine to create different acoustic force fields. The apparatus 100 includes a control device 120 for controlling the acoustic wave generators 112 to create the different acoustic force fields. The control device 120 is operable to change the phase, frequency and/or amplitude of the acoustic waves produced by each of the acoustic wave generators 112 in order to create the different acoustic force fields, and to control the time each of the different acoustic force fields is applied for. The control device 120 is configured to control the acoustic wave generators 112 to switch between the different acoustic force fields to create low, intermediate and high force impulse control modes or as will be described.

A particular example of apparatus 100 to illustrate methods of acoustic control of particles in accordance with examples of the present invention will be described. Apparatus 100 corresponds in general to apparatus 10. In more detail, the acoustic wave generators 112 of apparatus 100 are arranged in a circular array. In this example, the acoustic wave generators 112 are transducers in the form of piezoelectric elements with respective control electrodes, capable of generating ultrasonic acoustic waves. Each acoustic wave generator 112 is connected to the control device 120 for operation thereof via the control electrodes to create respective acoustic waves and to change the phase, amplitude of the acoustic waves and time they are applied for. The acoustic wave generators 112 are set within a housing (not shown) and the space 114 is centrally positioned therein. In examples, the housing may be a Petri dish. The space 114 is sealed and filled with water with microparticles suspended in the water. In examples, the space 114 may not be sealed and may be open. In examples, the space 114 may be filled with a different fluid. For example, the fluid may be a fluid which promotes biological cell growth, e.g. Unset agar. Other fluids may be commercially available fluids such as Dulbecco's Modified Eagle's Medium or Cellgro. For smart material applications, the fluid may be a photocurable resin, e.g. acrylate or PDMS resins, e.g. Spot-LV. In examples the fluid may be a non-Newtonian fluid, and examples include jelly or jelly-like materials, or other gel or gel-like materials. In examples, the space 114 may be filled with a gas, e.g. helium, in which the particles are positioned. In examples, space 114 may be filled with more than one type of fluid and/or non-fluid materials. In examples, the space 114 may include a solid or quasi-solid structure that is dimensioned such that it is not substantially affected by the acoustic fields whilst the particles which are manipulated by the method may come into contact and/or otherwise interact, e.g. adhere, to the structure. For example, in one application, the structure may be a mesh or cell support scaffold through which acoustic waves can propagate either with minimal interference or with interference which can be accounted for and the particles may interact therewith to build upon the support scaffold. Each acoustic wave generator 112 faces inwardly towards the space 114 and a backing layer surrounds the acoustic wave generators 112 to absorb and prevent any reflected acoustic waves re-entering the space 114. There are 64 acoustic wave generators in total and the space is 10.98 mm in diameter. The control device 120 includes a 64 channel driver device for producing control signals to control the acoustic wave generators 112 and has a fastest update time of 0.074 seconds with a standard deviation of 0.003 seconds. The drive frequency for the acoustic wave generators 112 is 2.35 MHz and the wavelength of the acoustic waves generated by the acoustic wave generators 112 is 0.644 mm. In examples, an input voltage of 14V may be applied to the acoustic wave generators 112 so as to apply a force estimated as 1.1 pN which corresponds to an applied force impulse of 81.4 fNs. Using three different voltage settings, the force may be varied between 8.6×10⁻¹⁴ and 2×10⁻¹²N.

In more detail, the apparatus 100 may be calibrated using a Fibre Optic Hydrophone (FOH). The calibration process involves taking a point scan of each acoustic wave generator's 112 output at the centre of the space 14 to measure phase and amplitude with a calibration value being applied to account for any variation from the desired phase/amplitude outputs. The calibration process may be completed once in relation to all the acoustic wave generators 112 with the calibration values then applied to all the control signals used to control the acoustic wave generators 112. Other calibration techniques may be employed. For example, experimental methods such as tracking particle trajectories to visualise the acoustic fields, or using more accurate simulations of the apparatus 100, e.g. through finite element models.

The housing of apparatus 100 may include a closing member, e.g. a cover, which is coated with a lubricant, e.g. a WD-40 PTFE Dry Lubricant Spray to reduce friction between the closing member and the particles which are positioned on and, during use, move along, the surface of the closing member. The liquid with the particles added may be diluted to reduce the particle density using deionised water and a dilute detergent solution to reduce inter-particle forces. For the examples which will be described, the particles are 90 μm in diameter and known under the trade name Fluoresbrite (manufactured by Polysciences Inc., USA). In examples, the particles may range in diameter from up to 3 mm in diameter and as small as 1 μm in diameter. The particle diameter chosen will generally be selected dependent on the frequency of the acoustic fields being applied. If the frequency is increased, small particles may be manipulated and if it is decreased, larger particles may be manipulated. Accordingly, other particle diameters may be successfully manipulated using methods in accordance with the present disclosure. The particles may be made from any materials provided that there is a sufficient acoustic contrast between the particle and manipulation medium/fluid. The particles may include biological cells, bubbles or liquids. It will be appreciated that the examples provided are merely illustrative and are not limited by the particle size or the materials from which they are made.

In an example according to an aspect of the present disclosure, a method is provided for acoustic control of particles in a space, e.g. the space 114, which includes providing particles in the space 114 with the particles arranged in an initial state. The term state is used to denote, for example, a spatial distribution of the particles which may be one-, two- or three-dimensional spatial distribution, or a translational state defining the motion of the particles where the translational state is defined by reference to one-, two- or three-dimensional motion states. The method includes selecting a desired state of the particles in the space to be achieved through control of the particles and selectively creating different acoustic force fields to obtain the desired state of particles by changing the phase, frequency and/or amplitude of the acoustic waves and controlling the time each of the different acoustic force fields is applied for so that at least a portion of the particles move in a desired way in the space from the initial state, e.g. an initial spatial distribution or translational state of the particles, to the desired state, e.g. a desired spatial distribution or translational state of the particles. This involves performing two or all of the following steps:
a) switching between selected different acoustic force fields to create a low force impulse control mode in which low force impulses are exerted on the particles and the acoustic force field exerted on the particles is effectively the sum of the selected different acoustic force fields so that the particles move to an intermediate state prior to another step being performed, or move to the desired state;
b) switching between selected different acoustic force fields to create a high force impulse control mode in which high force impulses are exerted on the particles so the particles reach the equilibrium point(s) of the acoustic force field that is present by the time the next acoustic force field is applied so that the particles move to an intermediate state prior to another step being performed, or move to the desired state; and
c) switching between selected different acoustic force fields to create an intermediate force impulse control mode in which intermediate force impulses are exerted so that the particles move further towards the equilibrium point(s) of the acoustic force field that is present than in the low force impulse control mode without reaching them by the time next acoustic force field is applied so that the particles move to an intermediate state prior to another step being performed, or move to the desired state.

The method may be employed in one-, two- and three-dimensional spaces or states of the particles by which it is meant that the particles are placed in an environment where the number of effective dimensions defining the state of the particles is limited by the environment, e.g. the particles are confined to move in one-, two- or three-dimensions. For example, where particles rest on a surface, only two dimensions are relevant for defining the state of the particles. For the purpose of illustrating the method, examples will be described in relation to two-dimensional spaces or states of particles but it will be readily appreciated that the method may be employed in one- or three-dimensional spaces or states of particles.

According to an aspect of the present disclosure, where the space 114 is a two-dimensional or three dimensional space, a method is provided for acoustic control of particles in the space 114, which includes providing particles in the space 114 with the particles arranged in an initial state. The term initial state has the same meaning as defined above, but the initial state is a two-dimensional or three-dimensional state in relation this method. The method includes selecting a desired state of the particles in the space to be achieved through control of the particles and which is a two-dimensional state or three-dimensional state; and, selectively creating different acoustic force fields to obtain the desired state of particles by changing the phase, frequency and/or amplitude of the acoustic waves and controlling the time each of the different acoustic force fields is applied for so that at least a portion of the particles move in a desired way in the space from the initial state to the desired state which involves performing the following step of:
a) switching between selected different acoustic force fields to create a low force impulse control mode in which low force impulses are exerted on the particles and the acoustic force field exerted on the particles is effectively the sum of the selected different acoustic force fields so that the particles move to an intermediate state prior to another step being performed, or move to the desired state; and may include one or more of the steps:
b) switching between selected different acoustic force fields to create a high force impulse control mode in which high force impulses are exerted on the particles so the particles reach the equilibrium point(s) of the acoustic force field that is present by the time the next acoustic force field is applied so that the particles move to an intermediate state prior to another step being performed, or move to the desired state; and
c) switching between selected different acoustic force fields to create an intermediate force impulse control mode in which intermediate force impulses are exerted so that the particles move further towards the equilibrium point(s) of the acoustic force field that is present than in the low force impulse control mode without reaching them by the time next acoustic force field is applied so that the particles move to an intermediate state prior to another step being performed, or move to the desired state.

References hereinafter to a method refer to either of the methods according to the aspects above.

It will be understood that acoustic force fields can be thought of interchangeably with acoustic pressure fields in that the acoustic force fields are force vectors which are dependent on the gradients of the acoustic pressure fields for particles smaller significantly smaller than the wavelength. For particles of comparable size to the wavelength the force vectors can be obtained from analysis using the momentum flux integral [08].

For any of the steps above, switching may include switching between a pre-defined number of acoustic force fields in an alternating way, i.e. going from one acoustic force field to the next and then to the next acoustic force field and repeating the process in a loop. For any of the steps above, switching may include applying a first acoustic force field, and then applying a different second acoustic force field, and carrying on iteratively between a pre-defined number of different acoustic force fields without applying the same acoustic force field twice in completing a given step.

The term “intermediate state” refers to the state of the particles that is obtained in an intermediate step of the method and which state is later changed by another step of the method that is subsequently performed and so on until the desired state is achieved.

As will be explained, for any of the steps above, the selection of different acoustic force fields may be based on a number of different factors and desired movement or control of the particles to be achieved. A wide variety of different acoustic force fields may be employed as part of the present method.

This method may be performed using the apparatus 100 by having the control device 120 configured to operate the acoustic wave generators 112 to create the different acoustic force fields required in the space 114 in which the particles are positioned so as to control the particles in the desired manner.

As will be described, the control device 120 may be configured so that the steps a), b) and/or c) are performed in a pre-determined sequence to arrive at the desired state. The initial and desired states may correspond to different spatial distributions of the particles. The pre-determined sequence may include different sequences of the steps a), b) and/or c) as will be described in later examples.

In examples, the steps a), b) and/or c) may be performed in a sequence for which, after at least one, or after each, step is performed, the state of the particles is determined and, based on the determined state of the particles, a suitable one of the steps a), b) and/or c) is selected to obtain the desired state. This forms a control loop for which an adjustment of the state of the particles is based on the observed results of a preceding step, or sequence of steps.

In examples, the method may involve one or more of the steps a), b) and/or c) to be repeated over a number of cycles before another one of the steps a), b) and/or c) are performed. Each step may include for different ones of the steps a), b) and c) performed, performing the step with different selections of acoustic force fields. For example, for one or more or all of step a), b) and/or c), the respective step may include applying a first selection of acoustic force fields to arrive at an intermediate state of particles, and then applying a second, different, selection of acoustic force fields to arrive at a further intermediate state.

In examples, the method may include performing one or more sequences of the steps a), b) and/or c) to be repeated over a number of cycles. These sequence(s) may be performed before a further step a), b) and/or c) is performed, or before a different one or more sequences of the steps a), b) and/or c) are repeated.

Step a) utilises the inventive realisation by the present inventors that, in the low force impulse control mode, the switching between different acoustic force fields, e.g. 2-D acoustic force fields, effectively creates an acoustic force field which is the sum of the different acoustic force fields that are being switched between. The method permits a relatively straightforward way of creating a complex acoustic force field that will control the particles to move in a pre-determined way to a desired state, e.g. a desired spatial distribution which is a complex shape or pattern as will be described.

In examples, e.g. for step a), the method may include the different acoustic force fields including an acoustic force field which defines a localisation region for localising at least a portion of the particles and/or orientation of the particles. For example, the said acoustic force field may create the localisation region by defining a twin trap defining respective first and second high pressure regions which define the localisation region therebetween. In examples, the said different acoustic force fields may create respective twin traps defining the same localisation region so that the particles are retained in the same spatial position but the twin traps may be orientated differently to one another, e.g. at 90 degrees to each other, so that a rotational force impulse is applied to the particles which changes the orientation of the retained particles. This may be useful in examples where the particles are non-spherical and it is desirable to orientate the particles in a particular direction. In examples, the different acoustic force fields may include a plurality of acoustic force fields defining respective localisation regions. The localisation regions may be spaced apart from each other. The localisation regions may be positioned along a pre-determined pattern or shape and the desired or intermediate state of the particles may correspond to the pre-determined pattern or shape. The pre-determined pattern or shape may include one or more lines which may be straight and/or arcuate lines, e.g. to form circles or curves. The localisation regions may form a continuous region. The pre-determined pattern or shape may be a two-dimensional pattern or shape in examples.

In the low force impulse switching control mode, the equation (2.12) above, which states that the different acoustic force fields can be summed together in the low impulse force field control mode into a single acoustic force field, can be simplified for constant switching times to an acoustic force field denoted here as acoustic force field Fₚ:

$${F}_{P =} \frac{{\sum }_{q = 1}^{Q} {F}_{ac , q}}{Q}$$

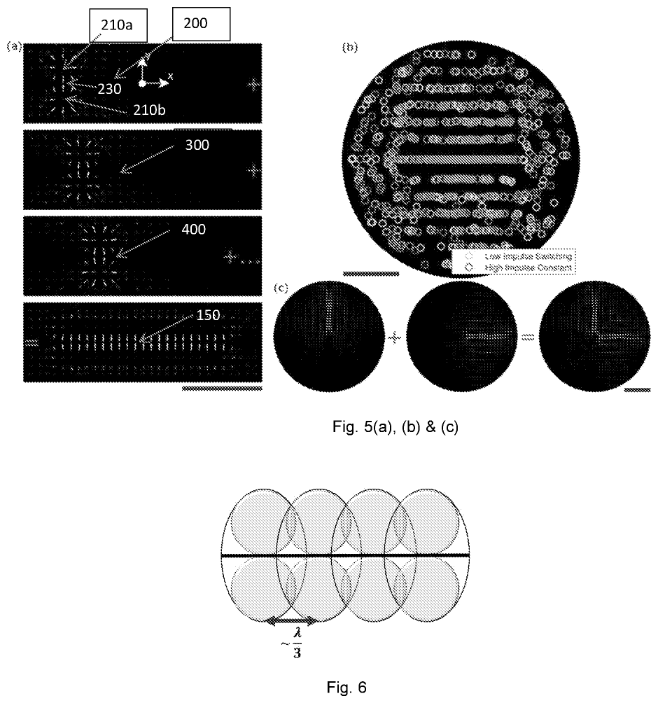

Referring to FIG. 5a, these images show the effective single acoustic force field Fₚ formed by switching, in the low force impulse control mode, between different acoustic force fields each having respective localisation regions according to example methods of the present disclosure. The effective acoustic force field is shown in the lowermost image and is formed from ten twin traps. The arrows scale in length and colour according to the magnitude of the force vector at the origin point. The uppermost image shows a first acoustic force field which forms a first twin trap 200 having a first high pressure region 210a and a second high pressure region 220b, with a localisation region 230 extending therebetween. The image immediately below shows a second twin trip 300, and image below that a third trip 400 with the traps 200, 300, 400 being arranged so that their respective localisation regions form a pre-determined pattern, here it is a line, which is best seen in the lowermost image. In FIGS. 5a, b and c, the blue/dark lines outside of the respective images are scale bars of 1 mm. In this example, the switching times may be constant.

In this example, a twin trap is used as a constituent element which localises a respective portion of particles in the space so as to form a part of the desired or intermediate state of particles to be achieved. The constituent elements can be effectively connected together to create an almost arbitrary pattern or shape as desired.

Referring to FIG. 6, this shows, schematically, the arrangement of the respective twin traps to form a final localisation region 150 that corresponds to a line which bisects the respective twin traps. In this example, the distance between the centre of each twin trap may be one third of the acoustic wavelength (λ/3) or slightly below this. This is used to calculate that, in order to create a pre-determined pattern which is a line of 2 mm length, ten twin traps are required, i.e. there must be ten different acoustic force fields which are switched between in the low force impulse control mode. In examples, the apparatus 100 may be arranged so that input voltage is around 7V (corresponding to an applied force of 402 fN) but the voltage may be varied depending on the environmental conditions at the particular time and the voltage can be varied between 5-10 V (corresponding to a range of applied forces of 230 to 660 fN creating a range of force impulses of 17 to 49 fNs).

In examples, it is possible to operate the acoustic wave generators 112 to create acoustic force fields that are first order Bessel functions (by which it is meant that the acoustic force fields approximate as close as practically possible to first order Bessel functions) with respective focus points and to use the same as constituent elements to form a final localisation region corresponding to a line. In examples, it is also possible to use vortex traps defined by acoustic force fields to form the constituent elements to form a final localisation region corresponding to a line.

FIG. 5(b) is an image showing two separate simulations of the acoustic force field of FIG. 5(a) which validates that the acoustic force field in the low force impulse control mode is the sum of the different acoustic force fields.

Two separate simulations of the force field in FIG. 5(a) are conducted on an initial state, here an initial spatial distribution, of particles which is random; and the final locations are plotted in FIG. 5(b) in relation to a first simulation (light/cyan coloured particles) corresponding to the low force impulse control mode that has been modelled as the sum of the different acoustic force fields to create the desired acoustic force field, whilst the second simulation (dark/magenta coloured particles) corresponds to the desired acoustic force field applied “as-is” in a steady state i.e. without being formed from switching between different constituent acoustic force fields. Both simulations were run for 500 ms with every force field normalised to a maximum force of 10 nN. In the low force impulse control mode, the switching time is 1 ms so that the maximum applied impulse by each field is 1×10⁻¹¹ Ns (within the low impulse control mode). In the desired acoustic force field arrangement having a steady state, the maximum impulse is 5×10⁻⁹Ns (within the high impulse control mode). In the central region of the space, i.e. the region in which the pattern is formed, where the force (and therefore force impulse) is strongest there is good agreement between the two methods of forming the same pattern. This illustrates the validity of equation (2.12) and the low force impulse switching approach/control mode. Note that the agreement is less good further from this central region because the force and, therefore force impulse, is weaker at the outer regions away from the central region.

FIG. 5(c) is an example of step a) of the method being used with acoustic force fields similar to those used in relation to the example of FIG. 5(a) to form a complex acoustic force field which is “L” shaped. The respective sides of the L are 1.5 mm in length with eight twin traps used per side of the L. By application of acoustic force fields having localisation regions in which the acoustic force fields are concentrated means that constructive interference between the acoustic force fields happens closest to the pre-determined pattern or shape formed by the respective localisation regions and any interference effects are minimised. The respective localisation regions, in turn, also correspond to the changed spatial distribution of the particles and so the present method permits a complex shape or pattern of particles to be formed using each acoustic force field as a building block in the low force impulse control mode.

In the low force impulse mode, for the apparatus 100, the voltages applied for the respective acoustic waves which created the acoustic force fields may be between 5 and 10V.

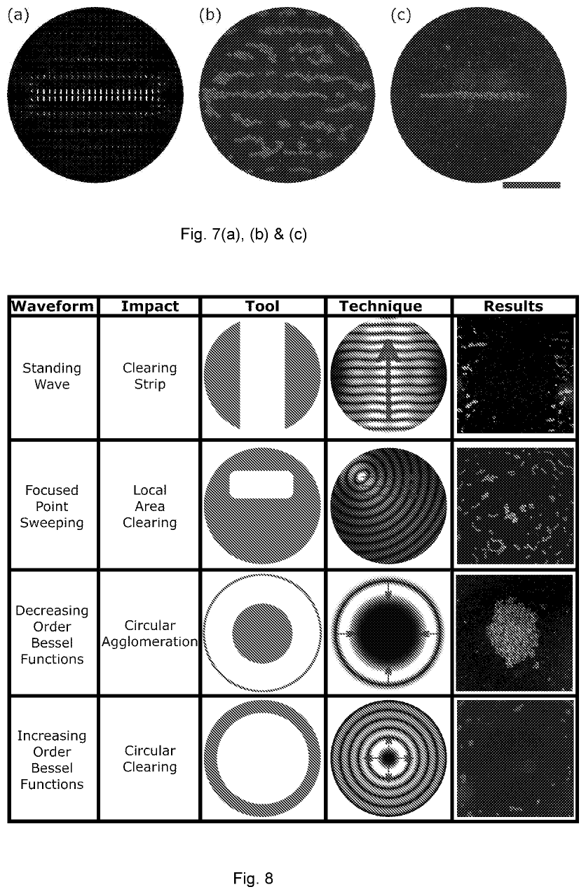

FIG. 7(a) is an image from a simulation which shows the summed or effective acoustic force field produced by switching between acoustic force fields in the low force impulse control mode where the acoustic force fields each include a localisation region formed by the acoustic force field defining a twin trap. The summed or effective acoustic force field created thereby produces a localisation region which follows a line pattern. FIG. 7(b) is an image from an experimental test where the summed acoustic force field of FIG. 7(a) has been applied to an initially random state, here a spatial distribution of particles. The line of particles is well defined at the central region of FIG. 7(b) but there is an issue in the rest of the particles in the space making it harder for the line of particles to stand out clearly.

The method according to examples of the present disclosure includes employing steps that can be used to resolve this issue and result in a clear line of particles as shown in the experimental result shown in FIG. 7(c). In FIGS. 7(a) to (c) the dark line outside of FIG. 7(c) is a scale bar of 1 mm.

In this respect, a number of different techniques or method tools in accordance with examples of a method according to the present disclosure may be employed. These are illustrated in the table of FIG. 8. Column 1 (header “Waveform”) refers to the form of the acoustic waves generated by the acoustic wave generators 112. Column 2 (header “Impact”) refers to a generic term for the method tool and the effect each of the associated acoustic waveforms has. Column 3 (header “Tool”) is a schematic illustration of the shapes/patterns within the space that are affected by the respective acoustic waveforms. Column 4 (header “Technique”) shows the acoustic force field/pressure fields created by the respective acoustic waveforms. Column 5 (header “Results”) shows images from experimental results showing the changed state, here spatial distributions, of the particles after the respective acoustic waveforms have been applied.

Many of the techniques involve the method including a step b) of switching between the different acoustic force fields in the high force impulse control mode. In some examples, the techniques may involve using higher voltages, e.g. 20V/1.5 pN, at smaller numbers of repetitions, e.g. 5, to remove or clear particles towards the remote parts of the space.

In examples, for step b), the different acoustic force fields may include two or more acoustic force fields formed from standing waves having different phases, and includes switching between respective ones of the two or more acoustic force fields iteratively in a cycle in the high force impulse control mode so that the particles reach the equilibrium points of the acoustic force field that is present by the time the next one of the two or more acoustic force fields is applied. This switching between the respective ones of the two or more acoustic force fields may be repeated until all or a substantial number of the particles have been moved to a remote part of the space 114. This would have the effect of moving particles out of the region over which the respective ones of the two or more acoustic fields, which form the standing waves, extend.

For example, reference is made to row 1 of the table in FIG. 8 to describe a specific example/method tool denoted as a “clearing strip method tool” for clearing particles from a large area or region of the space. In this example, acoustic force fields are employed to create three standing waves separated by a phase of 2π/3. The acoustic force fields are switched between in the high force impulse control mode so as to move the particles a short distance. Because they are switched in the high force impulse control mode, the particles will settle into the equilibrium points of the respective standing wave acoustic force field that has been applied before the next, progressed, standing wave acoustic force field is applied. This process is repeated causing the particles to be progressively moved to the outer regions of the space. In this example, each standing wave acoustic force field is formed by only operating acoustic wave generators 112 that are opposite each other within a set width dimension across the space. So, in a specific example, for a width dimension of 3 mm, there may be 11 acoustic wave generators at opposite ends across this width dimension with 22 acoustic wave generators used in total. The phase of the acoustic wave generators 112 may need to be adjusted based on the relative position of the acoustic wave generators 112 and the shape of the array that is formed by them. For example, for the apparatus 100 having a circular array of acoustic wave generators 112, in addition to the phase shift 2π/3 between the respective standing waves, a phase shift of kd_{w} must be applied to each acoustic wave generator 112 where k is the wavenumber and d_{w} is the distance from the acoustic wave generator 112 to a line parallel with the wavefront of the standing wave. Experimental results achieved when applying clearing strip method tool are shown in the last column of row 1 of the table. It can be seen that nearly all of the space in a strip across 114 has been cleared of particles.

Referring to the third row of the table in FIG. 8, another example/method tool denoted here as a “circular agglomeration/localisation method tool” for localising or agglomerating particles in a circle or spherical region will be described in relation to step b) of operating in the high force impulse control mode. In this example, for step b), the selected different acoustic force fields may include two or more acoustic force fields formed from n^{th} order Bessel functions having respective focus points and includes switching between respective ones of the two or more acoustic force fields from higher to lower n^{th} order Bessel functions iteratively so that the particles move away from the high pressure ring towards the focus point(s) of the acoustic force field that is present by the time the next one of the two or more acoustic force fields is applied such that the particles agglomerate in a localised, e.g. central, area of the space 114. By progressively reducing the order of the Bessel function in the high force impulse control mode, particles are forced to move inwardly towards the centre of the acoustic force field applied causing the particles to become localised there. In examples, it may be preferable to repeat this switching a pre-determined number of cycles. In examples, it may be preferable to apply changes in phase between the respective acoustic wave generators required to form the Bessel function shaped acoustic force fields in an inverted way between cycles such that the phase may increase in a clockwise direction in a first cycle and the phase may increase in an anticlockwise direction in a second, next, cycle. In examples, it may be preferable to select the order of the Bessel function shaped acoustic force field being applied so that the applied field does not fall within or below the size of the area/region over which the particles have been localised/agglomerated. It may be preferable to select the order of the Bessel function so that it is larger than the desired localised area or region over which particles are agglomerated.

Experimental results achieved using the circular agglomeration/localisation method tool described in the preceding paragraph can be seen in the last column of the third row of the table of FIG. 8. It can be seen that nearly all of the particles have been localised and agglomerated in the central region thereby forming a generally circular shape.

Referring to the fourth row of the table in FIG. 8, another example/method tool denoted here as a “circular clearing method tool” for clearing particles from a circular area or spherical region will be described in relation to step b) of operating in the high force impulse control mode. In this example, for step b), the selected different acoustic force fields include two or more acoustic force fields formed from n^{th} order Bessel functions and the method includes switching between respective ones of the two or more acoustic force fields from lower to higher n^{th} order Bessel functions iteratively so that the particles move away from the high pressure ring and towards the equilibrium point(s) of the acoustic force field that is present by the time the next one of the two or more acoustic force fields is applied such that the particles agglomerate or localise around a remote area of the space. This method tool/technique is similar to the circular agglomeration/localisation method tool and a similar process occurs but in the opposite sense so as to move particles away from the focus point of the Bessel function being applied. If the focus point is selected as the central region or area of the space 114, then particles will be cleared from this region/area. The last column of the fourth row shows the experimental results achieved with this technique. It can be seen that the nearly all of the space 114 has been cleared of particles.

Either of the examples described in relation to the circular agglomeration/localisation method tool and circular clearing method tool may be deployed such that the respective Bessel functions are focussed away from the central region or area of the space to move particles towards/away from this region/area respectively. However, it may necessary to repeat the respective techniques over a number of cycles in order to obtain better results depending on the relative force field strengths for the particular apparatus configuration adopted.

Either of the examples described in relation to the circular agglomeration/localisation method tool and circular clearing method tool may be deployed in the high force impulse control mode with switching times as long as 1 second and with voltages as high as 20V (which is a force impulse of 1.5 nNs). If desired, a lower switching time or voltage may be set to create a more localised effect on the particles.

Referring to the second row of the table in FIG. 8, another example/method tool denoted here as a “local area clearing method tool” for clearing particles from a localised area or region of the space will be described in relation to step c), i.e. operating in the intermediate force impulse control mode. In this example, the different acoustic force fields include two or more acoustic force fields formed from Bessel functions having respective focus points that form a line and includes switching between respective ones of the two or more acoustic force fields iteratively so that the particles move away from the focus point towards the equilibrium points of the acoustic force field that is present by the time the next one of the two or more acoustic force fields is applied such that a localised area of the space around the line is cleared of particles. Each Bessel function may be of the same order. By way of example, each Bessel function may be a 0^{th} order Bessel function so as to clear particles about a line/region around the line formed by the respective focus points of the Bessel functions. In examples, step c) may include clearing a plurality of lines, e.g. parallel lines, each line being formed by respective focus points of Bessel functions which form the acoustic force fields that are switched between to clear each respective line, so as to clear a larger area over which the lines extend. The last column of the second row shows an experimental result achieved employing the local area clearing method tool. It can be seen that a small rectangular area has been cleared of particles. In examples employing the local area clearing method tool, a relatively higher voltage range of 7-15V (forces of 402 to 1090 fN) may be used and is dependent on the environmental conditions/experimental set-up but can be readily deduced by the skilled person.

According to examples of the present disclosure, steps a), b) and/or c) may be performed in a pre-determined sequence, or observing the state of the particles after a step, or number of steps have been performed and then selecting a suitable step based on the observed state in the manner of a control loop. These steps may include employing any of the method tools discussed previously to arrive at a final state. Doing so may be advantageous in achieving a clear spatial pattern, shape, or translational motion of particles from an initially random state, e.g. random spatial arrangement or random translational state of particles.

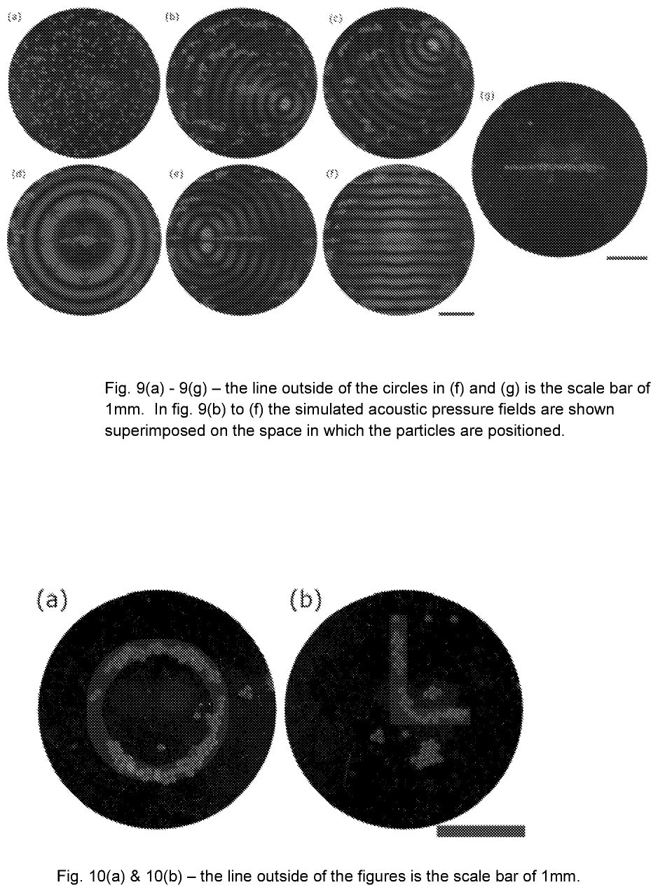

Referring to FIGS. 9(a) to (g), an example of how the steps a), b) and c) may be combined in different ways and sequences will be described.

By way of one example, FIGS. 9(a) to (g) are images from an experiment in which the steps have been combined to form a line of particles from an initially random spatial arrangement of particles. Other combinations of steps and sequences of steps may be employed in examples. FIG. 9(a) shows an initially random spatial arrangement of particles and the subsequent FIGS. 9(b) to (g) show the spatial arrangement changing on deployment of the method steps until a well-defined single line of particles can be seen in FIG. 9(g). In the first stages, shown in FIGS. 9(b) and 9(c), the intermediate force impulse control mode is utilised through use of the local area clearing method tool, i.e. focus point sweeping, being applied so that an area below the desired line of particles to be formed is cleared in a single repetition, and then an area above the line is cleared but with a lower intermediate force impulse applied to avoid drawing particles away from the line. The latter is repeated twice to account for the lower force impulse applied. At this stage, as is visible from FIG. 9(c), a rough collection of particles form a somewhat defined line. This will then be reinforced by applying low impulse method step to form a better defined line as described in previous sections of the description. As shown in FIGS. 9(d) and (e), then the high force impulse control mode is utilised through the use of the circular clearing method tool employed to apply increasing order Bessel functions shaped acoustic force fields. In this case, increasing from n=9 to n=20 and with alternating helicities being applied and a low force impulse control mode being applied which utilises acoustic force fields defining localisation regions through twin traps to reinforce the line as necessary should the line become distorted. Finally, a high impulse control mode of a single standing wave state is used as a supplement to the low impulse twin trap based line to reinforce the line and obtain a more even distribution of particles along the length of the line as shown in FIG. 9(g). In this case the standing wave is not used to move the line. It will be appreciated that this applied field is useful for reinforcing the line now that the particles in close proximity have been removed by the preceding steps.

FIG. 10(a) shows the results obtained by combining the low force impulse control mode of step a) and the high force impulse control mode of step b) of the method.

FIG. 10(a) shows a generally circle shaped spatial distribution of particles obtained from an initially random state, here random spatial distribution, of particles such as that of FIG. 9(a). This was obtained by first conducting a step b) which involved a first stage of localising/agglomerating the particles around the central region of the space by switching between Bessel function shaped acoustic force fields from higher to lower nth order Bessel functions of the first kind and a second stage of clearing the particles that were not agglomerated in the first stage by switching between Bessel function shaped acoustic force fields from lower to higher nth order Bessel functions of the first kind. A step b) for clearing particles from the centre of the circle was employed to roughly form the circle. After this had been completed, a step a) was conducted whereby first and second acoustic force fields forming 5th and 9th order Bessel functions of the first kind having a common focus point were switched between in the low force impulse control mode with the respective high pressure rings of the first and second acoustic force fields defining a circular localisation region between them resulting in the particles being arranging into a circle shape as is visible in FIG. 10(a). In more general terms, in examples, different first and second nth and mth order Bessel functions may be used to form the first and second acoustic force fields, where m≥n+1 may be switched between in the low force impulse control mode of step a). Each of the Bessel functions has a high pressure ring surrounding its centre/focus point and these high pressure rings of the Bessel functions form a localisation region between them that may be circular in shape.

In examples, the method may include the plurality of component acoustic force fields in step a) including one or more sets of acoustic force fields, each set defining respective localisation regions positioned along a respective pre-determined pattern or shape. Step a) may include switching between the acoustic force fields of the one or more sets of acoustic force fields in a pre-defined sequence to effect movement of one or more portions of the particles from a first pre-determined pattern or shape to a second pre-determined pattern or shape.

This will be explained with reference to FIG. 10(b) which shows an initially horizontal line of particles having been manipulated by the above technique to form an L-shape. In this example, around half of the line of particles has been rotated clockwise by 90 degrees.

The technique involves having each set of acoustic force fields include respective localisation regions positioned along a respective pre-determined line which effectively corresponds to the shape of the line of particles in a respective intermediate line shape as half the line is rotated about roughly its midpoint though 90 degrees. Each set of acoustic force fields thus produces a given intermediate line shape that occurs as part of the rotation of the line. By switching through the acoustic force fields of each set in the low force impulse control mode until the particles are positioned along the respective pre-determined line of that set, and before then moving to the next set of acoustic force fields, the particles will slowly be manipulated to have rotated to reach the final L-shaped line of FIG. 10(b).

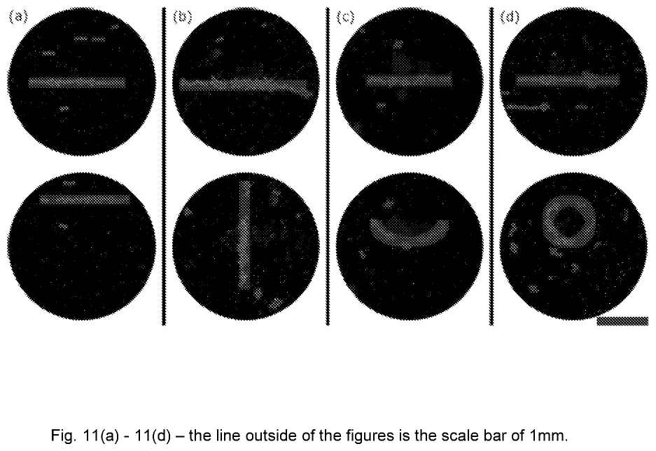

FIGS. 11(a) to (d) show results obtained by the low force impulse control mode step a) as will be explained.

FIG. 11(a) shows movement of a horizontal line of particles from a central position (top image) to an upper position (bottom image) over a 1 mm distance in a direction which is perpendicular to the line. This was achieved by incremental steps. At each step, switching occurred in the low force impulse control mode where the acoustic force fields include respective sets of acoustic force fields having respective localisation regions defining a horizontal line that is 0.1 mm displaced from the line of the preceding set of acoustic force field lines. Each set of acoustic force field lines effectively defines one of the interim lines of particles that are spaced at intervals of 0.1 mm and by switching between each set, the particles move from being in one line to the next line.

FIG. 11(b) shows rotation of a horizontal line of particles at a central position (top image) to a vertical line (bottom image) of particles, i.e. a rotation of 90 degrees. This achieved in a similar way to the method described in the preceding paragraph except that each incremental line created by the respective set of acoustic force fields is rotated 5 degrees with respect to the preceding line.

FIG. 11(c) shows the deformation of a line of particles into an arc. This is achieved in a similar way to the method above except each step is the arc of equal length to the original line (2 mm) for a circle of varying radius. For each of these steps the radius is also equal to the distance of the centre of the circle from the line. The arcs were formed of low force impulse control mode twin traps. As the changes in the amount of deformation became greater the shorter the radius it was deformed by the following steps: between 5 mm and 3 mm 0.5 mm/step, between 3 mm to 1 mm 0.25 mm/step, at less than 1 mm 0.12 mm/step.

FIG. 11(d) shows the deformation of a line of particles into a circle. In the same way as FIG. 11(c) the line was deformed but this progressed further until the particles were arranged in a circle. At this point the arc (previously formed of low impulse twin traps) was now changed to two low impulse Bessel functions of 2^{nd} and 6^{th} order Bessel functions. The chirality of these Bessel functions was alternated to achieve better distribution of the particles.

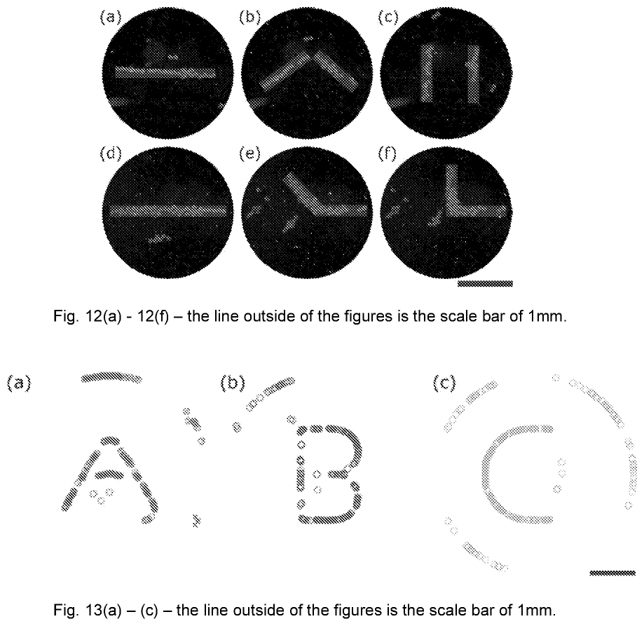

FIGS. 12(a) to 12(c) show further manipulation/control techniques that can be achieved through use of methods according to the present invention. An initial horizontal line of particles (FIG. 12(a)) is divided into two parts with the respective parts subsequently rotated in opposite directions (FIG. 12(b)) until the two parts extend vertically (FIG. 12(c)). This is achieved in a similar way to the method described to create the L-shape of particles shown in FIG. 10(b).

FIGS. 12(d) to 12(f) show further manipulation/control techniques that can be achieved through use of methods according to the present invention. In this case, similar to the method described to create the L-shape of particles shown in FIG. 10(b), one half of the initially horizontal line is held in place whilst the other half is rotated (FIG. 12(e)) with both halves remaining connected through the entire process until the final L-shape is achieved (FIG. 12(f)).

FIG. 13(a) shows a simulated ‘A’ shape. The shape pattern is made by applying, in the low force impulse control mode, acoustic force fields that form a selection of twin traps to create the inclined and non-inclined sides of the shape and also a small number of 0^{th} order Bessel functions to complete providing form to the final features such as the edges at the end of the crossbar. This shape pattern is formed by a tool which, in general terms, forms localisation regions by the acoustic force fields defining twin traps each having respective first and second high pressure regions which define localisation regions therebetween and the localisation regions are formed as part of step a) of the method. The twin trap(s) may be formed by the acoustic force field(s) being Bessel functions of the first kind, e.g. 0^{th} order Bessel functions, with a phase offset to transform them into twin traps and the acoustic force field(s) may include one or more further Bessel functions of the first kind, e.g. 0^{th} order Bessel functions, whose high pressure regions are positioned near the localisation region(s) to assist in defining the localisation region(s). This may be applied as part of steps a), b) or c) to form the desired localisation region(s). This tool is useful for examples where the localisation required is geometrically incompatible to solely using twin traps formed using acoustic force fields that are Bessel functions of the first kind. By applying further Bessel functions of the first kind at areas of the geometric incompatibility, they assist in forming the required localisation regions and cure this issue. This tool can be used as a standalone tool as part of a method and not just the particular method described in this example to create the ‘A’ shape.

Turning to the example of FIG. 13(a), the formation of this shape from an initial state that is a random arrangement of particles involves applying the circular agglomeration/localisation method tool in the high force impulse control mode by switching from a 20^{th} order Bessel function down to a 12th order Bessel function iteratively with the focus points thereof being around the origin [x,y]=[0,0] mm. The next step is to clear an area between the legs of the ‘A’ by applying the circular clearing method tool in the high force impulse control mode by switching from a 0th order Bessel function up to a 6^{th} order Bessel function iteratively with the focus points thereof being at [0, −1.2] mm. The next step is to pattern to the desired shape. This involves first applying a high force impulse control mode 0^{th} order Bessel function at [0,0.33] mm to clear out the centre gap at the top of the ‘A’ before the shape is formed by applying the low force impulse control mode pattern for the first time. The sides of the ‘A’ shape are now reinforced by applying a sequence of standing waves in the high force impulse control mode. Each standing wave in the sequence has a width of 1 mm. The sequence, including the location and orientation of each standing wave in the sequence is as follows (where 0° is parallel to the y-axis and a positive angle represents a clockwise motion):: 1. [1.4,0] mm, −30°; 2. [−1.4,0] mm 30°; 3. [0, 1.4] mm, 90°; 4. [1.4,0] mm, −30°; 5. [0, 1.4] mm, 90°; 6. [1.4, 0] mm, −30°; and 7. [0,1.4] mm, 90°. After each step the ‘A’ shape pattern was formed using the twin traps and Bessel functions as referenced at the beginning of this paragraph. This represents the sequence required to obtain the light/orange circles which was systematically applied. As with previous systems there are still a small number of particles outside the pattern. The dark/blue crosses indicate in the end results of a custom clearing approach which applies the method of the present disclosure using steps a), b, and/or c) based on the observed locations of these particles previously referenced as a control loop. This was obtained by applying the intermediate force control mode using Bessel functions to remove those particles from close proximity to the ‘A’ pattern and then using the clearing strip method tool in the high impulse control mode to remove them to the edge of the clearing area. To remove the particles from between the legs of the ‘A’, high impulse control mode application of a Bessel function was cycled down from 2^{nd} to 1^{st} order at [−0.15,−0.5] mm then moving this 1^{st} order Bessel function down to [−0.15,−1.5] mm with 0.1 mm steps and a reinforcement of ‘A’ at [−0.15,−0.9] mm then again at the final location. To remove the particles just below the right leg of the ‘A’ a 1st order Bessel function was moved from [0.8,−1] mm down to [0.8,−1.5] mm with 0.1 mm steps and an ‘A’ reinforcement at the end. A standing wave of 1 mm width centred on [0,−1.4] mm with 90° orientation then swept them all to their finishing location and the ‘A’ shape was reinforced again.

In general terms, the example describes a tool for which the method includes performing a step b) for which the selected different acoustic force fields include two or more acoustic force fields formed from standing waves having different phases, and includes switching between respective ones of the two or more acoustic force fields iteratively in a cycle in the high force impulse control mode so that the particles reach the equilibrium points of the acoustic force field that is present by the time the next one of the two or more acoustic force fields is applied and this is completed after a step a) has been performed to reinforce a pre-determined shape or line created by step a). This tool may be employed as a standalone tool in isolation or as part of a method including further steps.

FIG. 13(b) shows a simulated ‘B’ shape. The formation of this shape from an initial state that is a random arrangement of particles involves applying the circular agglomeration/localisation method tool in the high force impulse control mode by switching from a 20^{th} order Bessel function down to a 11th order Bessel function iteratively with the focus points thereof being around the origin [x,y]=[0,0] mm so that the particles are agglomerated around the origin. The hollows of the ‘B’ were formed by applying the circular clearing method tool in the high force impulse control mode using 0^{th} through to 3^{rd} order Bessel functions with focus points at [0,0.5] mm and then at [0,−0.5] mm. The indentation at the right was then created by applying the same tool/impulse control mode but now iterating from 0^{th} to 2^{nd} order Bessel functions with focus points at about [1.1,0] mm. A low force impulse control mode was then applied to form the ‘B’ by using a combination of twin traps and 0^{th} order Bessel functions. Similar to that described in relation to the example of FIG. 13(a), standing waves were then used in the sequence (same reference points/system): 1. [−1.9,0] mm, 0°; 2. [0,1.7] mm, 270°; 3. [1.5,0] mm, 0°; 4. [−1.9, 0] mm, 0°; and 5. [0,1.7] mm, 270°. After each step the ‘B’ shape pattern was formed using a combination of twin traps and Bessel functions as referenced above.

FIG. 13(c) shows a simulated ‘C’ shape. The formation of this shape from an initial state that is a random arrangement of particles involves applying the circular clearing method tool in the high force impulse control mode by switching from a 0^{th} order Bessel function up to a 6^{th} order Bessel function iteratively with the focus points thereof being at [1.1,0] mm, and then again with the focus points being [0.1,0] mm. The clearing strip method tool in the high impulse force control mode was then applied using standing waves to clear around the edges. The standing waves each had a width of 1 mm. The standing waves (using the same reference system as used in relation to FIG. 13(a)) had the following centres and orientations: [0,−1.7] mm, −90°; [0,1.7] mm, −90°; [1.3, 0] mm, 0°. Then the circular agglomeration/localisation method tool was applied in the high force impulse control mode using Bessel functions which decreased iteratively from 18^{th} to 12^{th} order and having focus points at the origin. Finally, the C shape was patterned by applying a low force impulse control mode utilising twin trap patterning.

According to an aspect of the present disclosure, a method for calibrating an apparatus for performing a method for acoustic control of particles in a space is provided. The apparatus may share features in common with the apparatus 100 and, for the purpose of this example, the apparatus 100 is the same as apparatus 10. According to an example of the method of calibration, the control device 120 is configured to control the acoustic wave generators 112 to switch between different acoustic force fields to exert force impulses on a particle.

The method includes selecting a pre-determined acoustic force field or acoustic force fields to be created to control movement of a particle in the space 114. The method then includes applying or switching between the pre-determined acoustic force field(s) to hold the particle in position in the space. The method includes, in a next step, altering the pre-determined acoustic force field or acoustic force fields to exert a force impulse to move the particle along a path for a first set of acoustic wave generator time applied and maximum amplitude settings. For the apparatus 100, the maximum amplitude settings are generally defined by the input voltages applied to the acoustic wave generators. The method includes observing movement of the particle to determine the type of force impulse that has been applied to the particle. The method then involves using the preceding steps to calibrate the control device in controlling the acoustic wave generators to obtain the desired force impulse to be applied on the particles to acoustically control the particles.

The method steps may include determining whether the type of force impulse is a low force impulse, a high force impulse, an intermediate force impulse or whether a minimum force has been achieved to move the particle from a stationary state. Where the method involves switching between pre-determined acoustic force fields, the determination may include determining whether the particle has moved in accordance with one of a low force impulse control mode, an intermediate force impulse control mode and a high force impulse control mode. These terms have the same meaning and interpretation as provided in the preceding sections of the description.

The method may be repeated for further one or more sets of acoustic wave generator applied time and maximum amplitude settings, and one of the applied time or amplitude settings is increased/decreased for each repetition to determine for which settings the particle moves in accordance with a different one of a low force impulse control mode, an intermediate force impulse control mode, and a high force impulse control mode.

The method may be used to calibrate the apparatus 100 so that the settings required to obtain the high, low and intermediate force impulse control modes can be identified. The method may also permit an identification of the settings required to move the particles in a desired way against the forces which act upon it in the apparatus. These forces include the acoustic field force, the Stokes drag, and the friction caused by the particle resting on a surface of the apparatus. The acoustic field forces may also vary due to the interaction between the acoustic field and the surface on which the particles rest. As such, it is advantageous to utilise a calibration method to identify the necessary settings to permit a closer alignment of the particle behaviour to that which is desired compared to relying solely on theoretical modelling or simulations.

In examples, the pre-determined acoustic force field or acoustic force fields may be formed as a trap for holding the particles in a localisation region similar to the acoustic force fields described in earlier examples used to hold particles in a localisation region or regions. The trap may be formed from a vortex trap. For example, it may be formed by an acoustic force field created by a first order Bessel function. In examples, the trap may be by an acoustic force field created by a standing wave.

In examples, the calibration may be performed for different regions or areas of the space. The calibration methods described may be performed prior to carrying out the methods previously described for controlling the particles so that the particles move as closely as possible to the desired spatial distribution.

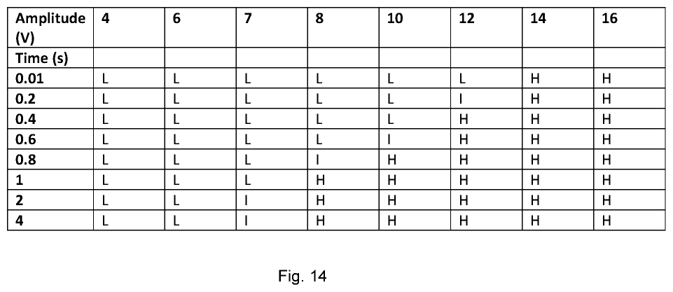

A detailed example of a specific method of calibration will now be described with reference to the table of FIG. 14. In this method, the force impulse applied to particle for a given maximum amplitude, i.e. input voltage, and applied time is determined as follows.

Firstly a particle is trapped by acoustic force fields forming a vortex trap through the use of a first order Bessel function shaped acoustic force field. This is done for a set input voltage (which determines the maximum amplitude of the acoustic waves) and set applied time (which corresponds to the switching time).

Secondly the acoustic force fields are changed to move the location of the vortex trap along a straight line in a first direction and then moving backwards along the line in a second direction. In this example, the vortex trap was moved along a 1 mm line in 0.05 mm steps and then returned in the opposite direction (i.e. it travelled a total of 2 mm and finished at the start point)

Thirdly the particle is observed and its behaviour determined to fall within one of the following categories.

High force impulse mode: if the particle successfully follows the whole path, the set of parameters used is in this control mode.

Intermediate force impulse mode: if the particle follows some of the path but not all of it, e.g. it is ejected at the turning point or it leaves the vortex trap before the turning point, then the set of parameters used is in this control mode.

Low force impulse mode: if the particle does not move with the acoustic force field as it changes at all, or a significant amount, then the set of parameters used is in this control mode.

Below minimum force impulse limit: if the particle does not move at all, or very little, then the minimum force impulse has not been reached for the set of parameters used.

Referring to the table of FIG. 14, this tabulates the results obtained by maintaining a constant maximum voltage and then varying the applied time for a given set of results and then repeating the process for a higher constant maximum voltage to obtain a further set of results. L indicates low force impulse, I indicates intermediate force impulse and H indicates high force impulse.

The table reveals the intermediate impulse force control mode as lying across a diagonal line between varying settings that correspond to the high and low impulse control modes.

Extrapolation of settings can be done when conducting this method to reduce the number of iterations required. For example, where settings have identified a low force impulse control mode, extrapolation can be made that for all settings in the downwards direction, in terms of the maximum amplitude and applied time settings, the settings correspond to the low force impulse control mode. Similarly, extrapolation can be made in the opposite sense once a high force impulse control mode has been identified for a particular set of settings.

There is a minimum force impulse control mode because the particles must overcome the static friction limit. If the maximum acoustic field amplitude is not high enough the particle will never move regardless of the time the acoustic force field is applied for. In the table, the requisite setting to do this is 4V.

The table can subsequently be used to choose the settings for future impulse control modes.

In examples of the calibration method, it may be preferable to conduct the calibration method if a different type of particle and/or liquid is used in the apparatus, as well as to account for environmental conditions (including temperature and surface treatments).

In more elaborate examples of the calibration method, the method could include utilising switching between acoustic force fields that are to be used in a particular method of controlling the particles using the apparatus 100, e.g. the various methods described previously, or a particular technique, e.g. one of the method tools shown in FIG. 8.

In examples of the calibration method to be described, further control abilities may be obtained by observing the location of multiple particles as they move during the calibration method. For example, when the pre-determined acoustic field used in the method is a field that moves multiple particles simultaneously, such as the standing wave shown in FIG. 8.

In examples, observing the location of multiple particles as they move could also be used to determine the spatial dependence of a given acoustic force field produced in a particular force impulse control mode. As the acoustic force applied to the particles will vary spatially so will the type of force impulse control mode that is experienced by the particles. For example, the experienced force impulse control mode and subsequent motion of particles at the centre of the standing wave compared to outside of the standing wave in FIG. 8 will be different. It may be the case that, depending on the spatial dependence of the acoustic force field, a high force impulse control mode may be effective in a localised region, whilst an intermediate or low force impulse control mode may be effective further away from the localised region. If this spatial dependence is determined, then it is possible to tune the acoustic force field to have localised control of a single particle without effecting particles located elsewhere, or to apply different force impulse control modes at different locations simultaneously.

For example, where a vortex trap and/or other Bessel-function type fields are applied as the pre-determined acoustic force field, the spatial dependence or the type of force impulse control mode at a spatial position will be primarily radially varying. By conducting the calibration method above but also observing the motion of particles other than that at the centre of the trap, the same categorisations of the spatial dependence can be made for particles at varying starting radial distances from the centre of the trap.

For example, if, when carrying out the calibration methods, a particle is moved with each altering of the pre-determined acoustic force field, then the set of parameters used corresponds to the high force impulse control mode at this radial location. However, if the particle moves for some of the alterations, but not all of them, then the set of parameters corresponds to the intermediate force impulse control mode at this radial location. However, if the particle does not move with any of the alterations, including significant alterations, then the set of parameters used is in the low force impulse regime control mode or below the minimum force impulse control mode at this radial location. This permits a determination of the parameters and locations at which the respective force impulse modes are effective.

This specific form of calibration, e.g. when used with a vortex trap as the pre-determined acoustic force field, may be used to calibrate the settings required to manipulate a single particle without disturbing any of the particles around it. It could also be used with higher order Bessel-functions forming the pre-determined acoustic force field to achieve a similar effect with particles larger relative to the size of the wavelength. This calibration may be made more elaborate by calibrating for different centre locations of the trap and by accounting for different angular locations around the centre of the trap, e.g. vortex trap centre.

In accordance with an example aspect of the present disclosure, a method for calibrating the apparatus to perform a method of acoustic control of multiple particles in the space dependent on the position of each particle in the space, may include: selecting a pre-determined acoustic force field to be created to control movement of multiple particles in the space; applying the pre-determined acoustic force field to hold some or all of the particles in desired starting positions in the space; altering the pre-determined acoustic force field that is created to exert a force impulse for moving some or all of the particles along a path for a first set of acoustic wave generator time applied and maximum amplitude settings; observing movement of the particles to determine the type of force impulse that has been applied to each particle at each starting position; and using the preceding two steps to calibrate the control device in controlling the acoustic wave generators to obtain the desired force impulse to be applied on the particles at each position to acoustically control the particles.

In examples, the desired starting positions may be selected so that the force impulse applied to particles at the selected desired starting positions can be determined.

In examples, the method may be repeated with the desired starting positions in the space being random so that the particles are arranged in a random spatial distribution, and repetition of the method permits the force impulse applied to particles at selected positions to be determined.

In examples, the method includes observing the motion of the particles as they move and determining any spatial dependence of the type of force impulse that has been applied to the particles, e.g. a radial dependence of the force impulse.

The method may include the desired control of the particles as only moving a portion of the particles whilst the rest of the particles remain stationary.

In examples, the pre-determined acoustic field may be formed as a vortex trap, e.g. formed by an acoustic force field created by a Bessel function (this may be a first order Bessel function of the first kind or a higher than first order Bessel function of the first kind) and the method involves altering the pre-determined acoustic field so that only the particles held in the trap move and the rest of the particles remain stationary.

It will be appreciated that the method of controlling particles as previously described in the present disclosure may include calibrating the apparatus prior to the method being performed and using the parameters obtained from the calibration to perform the steps a), b) and/or c) in a way to a localised or specific region of the space that particles are present. In examples, the method includes performing a step a), b) and/or c) for which only a single, or portion of the particles are moved depending on the position(s) of the particle(s) as determined by the calibration methods described previously.

The amplitude of the acoustic waves generated by the acoustic wave generators can, in practice, vary depending on the location within the space 114 of the apparatus 100. The present calibration method may be used to determine this variance at different locations or distances to determine a more accurate indication of the actual amplitudes to assist in calibrating the maximum amplitude setting accordingly.

In examples, the apparatus 100 may be combined with an acoustic hologram that may define a number of constituent parts of the desired spatial distribution of particles, e.g. it may define part of the shape or pattern of particles to be formed in the space. This would advantageously permit highly complex acoustic force fields to be created whilst maintaining the flexibility inherent with the apparatus 100 being a dynamic array of acoustic wave generators 112. The acoustic hologram may have, for example, multiple shapes defined therein and these shapes may be switched between as part of the method. The shapes could be separated spatially or by input frequency. In the context of the present disclosure, an acoustic hologram refers to an object placed in front of an acoustic wave generator source (which may be an array of acoustic elements, or a single acoustic element) and which applies a phase and/or amplitude change to the acoustic field produced by the acoustic wave generator. Known types of acoustic hologram include having a change in thickness of the material (which has a different speed of sound to the acoustic medium) which forms the acoustic hologram, or to incorporate a so-called labyrinth formed of tubes having different lengths through which the sound passes. In other cases, the acoustic hologram may be a grid of binary elements which allow the sound to pass or note e.g. as in the example of a Holographic Microbubble Array. Acoustic holograms are referred to as acoustic metasurfaces, delay lines and kinoforms in the art.

The methods and apparatus as described in the preceding examples may advantageously permit the ability to obtain high precision control and/or manipulation of the particles through acoustic waves. This may permit the ability to create complex patterns of particles and/or to do this on a mass scale, rather than having to manipulate or control individual particles one at a time. This has promising applications in relation to patterning biological cells and systems that require highly complex patterns. For example, in the fields of tissue engineering to have applications including 3-D biological printing of organs or tissues through to synthetically created meat. In other applications, it may be used to pattern particles in manufacturing such as aligning carbon fibres in a structure or aligning particles within a smart material to, for example, increase material strength or other properties such as conductivity and flexibility of materials. In manufacturing it may also be used to pattern, position or align micrometre or millimetre scale components precisely and quickly.

In examples, the methods and apparatus described are also comparatively less costly and/or complicated than prior art techniques/apparatus.

In examples, the methods and apparatus described permit control of the particles in a 2-D plane which can permit a more scalable ability to include a larger number of traps for controlling the particles whilst also permitting the particles to be easily observed through a microscope.

In examples, the methods and apparatus described permit very clear/high pattern contrast patterns of particles that is important for certain technological applications.

In examples, the methods and apparatus described can be equally adapted for 3-D applications and control of particles in a 3-D space in a manner that will be readily appreciated by the skilled person in light of this disclosure. In such examples, the method and apparatus may include selecting the acoustic force fields to control the particles to move along, or be projected to lie in, a plane in a manner that will be readily appreciated by the skilled person in light of this disclosure.

In examples of 3-D applications, the array of acoustic wave generators may, for example, be formed as single sided arrays that extend across three dimensions and these could be used in conjunction with or without a reflector that could be flat or curved to focus the acoustic waves.

In examples, the acoustic wave generators may be arranged as single axis dual arrays with two sets of arrays centred around a single axis opposite each other. In variations, there may be dual axis arrays, consisting of two sets of the single axis dual arrays above single axis arrays at a right angle to each other. There may be tri-axis arrays, which are similar to dual axis arrays, but extend across all sides. In further a variation, the above arrays may be employed but without having an axial centre, for example, two parallel arrays that are offset about their centre.

In examples, the array may be arranged as spherical arrangement.

In examples, any of the arrays described in the present disclosure could be moved as part of the method so as to extend the space over which the arrays act. For example, a 2-D array may be moved.

In examples, a relatively simple array could be used in a two-dimensional plane, for example, two opposing acoustic wave generators, and a more complicated array may be used to manipulate particles in that plane. This could be extended to cover arrangements where there are multiple sets of two-dimensional arrays.

In examples, for any of the arrays described, the acoustic wave generators may be arranged differently. For example, arranged as a grid, radially arranged, randomly arrangement or pseudo-randomly arranged.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

### REFERENCES

[01] Courtney C R P, Demore C E M, Wu H, Grinenko A, Wilcox P D, Cochran S, Drinkwater B W. 2014 Independent trapping and manipulation of microparticles using dexterous acoustic tweezers. Appl. Phys. Lett. 104, 154103. (doi: 10.1063/1.4870489).
[02] Kirkeby O, Nelson P A. 1993 Reproduction of plane wave sound fields. The Journal of the Acoustical Society of America 94, 2992-3000. (doi: 10.1121/1.407330).
[03] Newman, J. 1977 Marine Hydrodynamics. Pg. 151, Cambridge Mass.: MIT Press.
[04] Bruus H. 2012 Acoustofluidics 7: The acoustic radiation force on small particles. Lab Chip 12, 1014. (doi: 10.1039/c2lc21068a).
[05] Gor'kov, L. P. Forces acting on a small particle in an acoustic field within an ideal fluid”, Dokl. Akad. Nauk SSSR, 140:1 (1961), 88-91.
[06] S. Massey, B. Ward-Smith, J. 2018 Mechanics of Fluids. 9th edn. Pg. 331 London: CRC Press. https://doi-org.bris.idm.oclc.org/10.1201/9781315272542.
[07] Muller P B, Barnkob R, Jensen M J H, Bruus H. 2012 A numerical study of microparticle acoustophoresis driven by acoustic radiation forces and streaming-induced drag forces. Lab Chip 12, 4617. (doi: 10.1039/c2lc40612h).
[08] R. Habibi, C. Devendran, and A. Neild, “Trapping and patterning of large particles and cells in a 1d ultrasonic standing wave,” Lab on a Chip, vol. 17, no. 19, pp. 3279-3290, 2017.

1. A method for acoustic control of particles in a space, the method including:
providing particles in the space, wherein the particles are in an initial state;
selecting a desired state of the particles in the space to be achieved through control of the particles; and,
selectively creating different acoustic force fields to obtain the desired state of particles by changing the phase, frequency and/or amplitude of the acoustic waves and controlling the time each of the different acoustic force fields is applied for so that at least a portion of the particles move in a desired way in the space from the initial state to the desired state which involves performing two or all of the following steps:
a) switching between selected different acoustic force fields to create a low force impulse control mode in which low force impulses are exerted on the particles and the acoustic force field exerted on the particles is effectively the sum of the selected different acoustic force fields so that the particles move to an intermediate state prior to another step being performed, or move to the desired state;
b) switching between selected different acoustic force fields to create a high force impulse control mode in which high force impulses are exerted on the particles so the particles reach the equilibrium point(s) of the acoustic force field that is present by the time the next acoustic force field is applied so that the particles move to an intermediate state prior to another step being performed, or move to the desired state; and
c) switching between selected different acoustic force fields to create an intermediate force impulse control mode in which intermediate force impulses are exerted so that the particles move further towards the equilibrium point(s) of the acoustic force field that is present than in the low force impulse control mode without reaching them by the time next acoustic force field is applied so that the particles move to an intermediate state prior to another step being performed, or move to the desired state.

2. A method for acoustic control of particles in a space, the method including:
providing particles in the space, wherein the particles are in an initial state which is a two-dimensional or three-dimensional state;
selecting a desired state of the particles in the space to be achieved through control of the particles and which is a two-dimensional state or three-dimensional state; and,
selectively creating different acoustic force fields to obtain the desired state of particles by changing the phase, frequency and/or amplitude of the acoustic waves and controlling the time each of the different acoustic force fields is applied for so that at least a portion of the particles move in a desired way in the space from the initial state to the desired state which involves performing the following steps:
a) switching between selected different acoustic force fields to create a low force impulse control mode in which low force impulses are exerted on the particles and the acoustic force field exerted on the particles is effectively the sum of the selected different acoustic force fields so that the particles move to an intermediate state prior to another step being performed, or move to the desired state; and may include one or more of the steps:
b) switching between selected different acoustic force fields to create a high force impulse control mode in which high force impulses are exerted on the particles so the particles reach the equilibrium point(s) of the acoustic force field that is present by the time the next acoustic force field is applied so that the particles move to an intermediate state prior to another step being performed, or move to the desired state; and
c) switching between selected different acoustic force fields to create an intermediate force impulse control mode in which intermediate force impulses are exerted so that the particles move further towards the equilibrium point(s) of the acoustic force field that is present than in the low force impulse control mode without reaching them by the time next acoustic force field is applied so that the particles move to an intermediate state prior to another step being performed, or move to the desired state.

3. The method according to claim 1, wherein the steps a), b) and/or c) are performed in a pre-determined sequence to arrive at the desired state and/or the initial and desired states correspond to different spatial distributions of the particles.

4. The method according to claim 1, wherein the steps a), b) and/or c) are performed in a sequence for which, after at least one, or after each, step is performed, the state of the particles is determined and, based on the determined state of the particles, a suitable one of the steps a), b) and/or c) is selected to obtain the desired state.

5. The method according to claim 1, wherein one or more of the steps a), b) and/or c) are repeated over a number of cycles before another one of the steps a), b) and c) are performed.

6. The method according to claim 1, wherein one or more sequences of the steps a), b) and/or c) are repeated over a number of cycles, optionally or preferably before a different one or more sequences of the steps a), b) and/or c) are repeated.

7. The method according to claim 1, wherein, for step a), the different acoustic force fields include an acoustic force field defining a localisation region for localising at least a portion of the particles and/or orientation of the particles.

8. The method according to claim 7, wherein the different acoustic force fields include a plurality of acoustic force fields defining respective localisation regions, and wherein each localisation region is for localising at least a portion of the particles, and wherein the localisation regions are spaced apart from each other.

9. The method according to claim 8, wherein the localisation regions are positioned along a pre-determined pattern or shape and the changed state of the particles corresponds to the pre-determined pattern or shape.

10. The method according to claim 8, wherein the pre-determined pattern or shape includes one or more lines and/or optionally or preferably the localisation regions form a continuous region, and optionally or preferably the one or more lines may include a straight line and/or an arcuate line, and/or wherein the pre-determined pattern or shape is a two dimensional or a three dimensional pattern/shape.

11. The method according to claim 8,
wherein the plurality of acoustic force fields include one or more sets of acoustic force fields, each set defining respective localisation regions positioned along a respective pre-determined pattern or shape, and optionally or preferably step a) includes switching between the acoustic force fields of the one or more sets of acoustic force fields in a pre-defined sequence to effect movement of one or more portions of the particles from a first pre-determined pattern or shape to a second pre-determined pattern or shape, and/or
wherein the localisation region(s) may be formed by the acoustic force field(s) defining a twin trap(s) each having respective first and second high pressure regions which define localisation region(s) therebetween, optionally or preferably the twin trap(s) are formed by the acoustic force field(s) being Bessel functions of the first kind with a phase offset to transform them into twin traps and/or optionally or preferably the acoustic force field(s) include one or more further Bessel functions of the first kind whose high pressure regions are positioned near the localisation region(s) to assist in defining the localisation region(s), and/or optionally or preferably the localisation region(s) are formed as part of step a).

12. The method according to claim 8, wherein at least one of:
i) the acoustic force fields are formed as Bessel functions and the localisation region(s) are formed between high pressure rings surrounding the respective focus points of the Bessel functions;
ii) the localisation region(s) may be formed by the acoustic force fields being formed as vortex traps each having respective centres which define the localisation region(s) therebetween;
iii) the localisation region(s) may be formed by first and second acoustic force fields forming nth order and mth order Bessel functions of the first kind, where m≥n+1, each having respective high pressure rings surrounding respective centres of the Bessel functions and which define the localisation region(s) therebetween; and
iv) for step b) the selected different acoustic force fields include two or more acoustic force fields formed from standing waves having different phases, and includes switching between respective ones of the two or more acoustic force fields iteratively in a cycle in the high force impulse control mode so that the particles reach the equilibrium points of the acoustic force field that is present by the time the next one of the two or more acoustic force fields is applied, optionally or preferably this is completed after step a) has been performed to reinforce a pre-determined shape or line created by step a), and optionally or preferably the switching between respective ones of the two or more acoustic force fields is repeated until all or a substantial number of the particles have been moved to a remote part of the space.

13. The method according to claim 1, wherein at least one of:
i) for step b), the different acoustic force fields include two or more acoustic force fields formed from n^{th} order Bessel functions of the first kind having respective focus points surrounded by respective high pressure rings and includes switching between respective ones of the two or more acoustic force fields from higher to lower n^{th} order Bessel functions of the first kind iteratively so that the particles move away from the high pressure ring towards the focus point and towards the equilibrium point(s) of the acoustic force field that is present by the time the next one of the two or more acoustic force fields is applied such that the particles agglomerate in a localised, e.g. central, region/area of the space;
ii) for step b), the different acoustic force fields include two or more acoustic force fields formed from n^{th} order Bessel functions of the first kind and the method includes switching between respective ones of the two or more acoustic force fields from lower to higher n^{th} order Bessel functions iteratively so that the particles move away from the focus point towards the equilibrium point(s) of the acoustic force field that is present by the time the next one of the two or more acoustic force fields is applied such that the particles move away from the focus point towards a remote area/region of the space;
iii) for step c), the different acoustic force fields include two or more acoustic force fields formed from Bessel functions having respective focus points that form a line and includes switching between respective ones of the two or more acoustic force fields iteratively so that the particles move away from the focus points towards the equilibrium points of the acoustic force field that is present by the time the next one of the two or more acoustic force fields is applied such that a localised area/region of the space around the line is cleared of particles; and
iv) the method steps include using an acoustic hologram, wherein the acoustic hologram may define one or more constituent parts of the desired/intermediate state of particles.

14. An apparatus for performing the method of claim 1 for acoustic control of particles in a space, the apparatus including:
acoustic wave generators for producing respective acoustic waves which combine to create the different acoustic force fields; and
a control device for controlling the acoustic wave generators to create the different acoustic force fields, wherein the control device is operable to change the frequency, phase and/or amplitude of the acoustic waves produced by each of the acoustic wave generators in order to create the different acoustic force fields, and to control the time each of the different acoustic force fields is applied,
wherein the control device is configured to control the acoustic wave generators to switch between the different acoustic force fields.

15. The apparatus according to claim 14, wherein at least one of:
i) the space includes a fluid in which the particles are contained;
ii) the fluid is a stationary liquid and/or may include non-fluid materials, e.g. a solid or quasi-solid structure;
iii) the apparatus includes a housing which defines a space and a surface on which the particles are positioned and/or move;
iv) the acoustic wave generators are arranged in an array that at least partially or completely surrounds the space and the acoustic wave generators face inwardly towards the space, optionally or preferably, to form a 2-D or 3-D array; and optionally or preferably the array is annular, optionally or preferably, a circle, a polygon and/or flat; and
v) the apparatus includes an acoustic hologram, wherein the acoustic hologram may define one or more constituent parts of the desired/intermediate state of particles.

16. The method according to claim 1, wherein the particles are microparticles and/or the acoustic waves are ultrasonic acoustic waves.

17. A method of calibrating an apparatus for performing a method for acoustic control of particles in a space, the apparatus including:
acoustic wave generators for producing respective acoustic waves which combine to create the different acoustic force fields; and
a control device for controlling the acoustic wave generators to create the different acoustic force fields, wherein the control device is operable to change the phase and/or amplitude of the acoustic waves produced by each of the acoustic wave generators in order to create the different acoustic force fields, and to control the time each of the different acoustic force fields is applied for; and
wherein the control device is configured to control the acoustic wave generators to switch between the different acoustic force fields to exert force impulses on a particle, and
wherein the method of calibrating the apparatus includes:
d) selecting a pre-determined acoustic force field to be created to control movement of a particle in the space;
e) applying the pre-determined acoustic force field to hold the particle in a desired position in the space;
f) altering the pre-determined acoustic force field that is created to exert a force impulse for moving the particle along a path for a first set of acoustic wave generator time applied and maximum amplitude settings;
g) observing movement of the particle to determine the type of force impulse that has been applied to the particle;
h) using steps f) and g) to calibrate the control device in controlling the acoustic wave generators to obtain the desired force impulse to be applied on the particles to acoustically control the particles.

18. The method according to claim 17, wherein step g) comprises determining whether the type of force impulse is a low force impulse, a high force impulse, an intermediate force impulse or whether a minimum force has been achieved to move the particle from a stationary state.

19. The method according to claim 17, wherein at least one of:
i) the method is repeated for further one or more sets of acoustic wave generator applied time and maximum amplitude settings, wherein one of the applied time or amplitude settings is increased/decreased for each repetition to determine for which settings the particle moves in accordance with a different one of a low force impulse control mode, an intermediate force impulse control mode, and a high force impulse control mode;
ii) the pre-determined acoustic force field is formed as a trap;
iii) the pre-determined acoustic force field is formed as a trap for holding the particles in a localisation region, and optionally or preferably the trap is formed from a vortex trap, optionally or preferably formed by an acoustic force field created by a first order Bessel function of the first kind;
iv) the pre-determined acoustic force field is a standing wave;
v) calibration for a plurality of pre-determined acoustic fields; and/or
performing calibration for pre-determined acoustic field formed as a twin trap and step f) includes moving the particle in opposite directions along the path;
vi) the calibration is performed for different regions or areas of the space; and
vii) the set of acoustic wave generator time applied and maximum amplitude settings are used to calibrate the control device in controlling the acoustic wave generators to obtain the desired acoustic control of the particles.

20. The method of according to claim 17, wherein the method is for calibrating the apparatus to perform a method of acoustic control of multiple particles in the space dependent on the position of each particle in the space, wherein
step d) includes selecting a pre-determined acoustic force field to be created to control movement of multiple particles in the space;
step e) includes applying the pre-determined acoustic force field to hold some or all of the particles in desired starting positions in the space;
step f) includes altering the pre-determined acoustic force field that is created to exert a force impulse for moving some or all of the particles along a path for a first set of acoustic wave generator time applied and maximum amplitude settings;
step g) includes observing movement of the particles to determine the type of force impulse that has been applied to each particle at each starting position; and
step h) includes using steps f) and g) above to calibrate the control device in controlling the acoustic wave generators to obtain the desired force impulse to be applied on the particles at each position to acoustically control the particles.

21. The method according to claim 20, wherein at least one of:
i) step e) includes the desired starting positions being selected so that the force impulse applied to particles at the selected desired starting positions can be determined;
ii) the method is repeated with step e) including the desired starting positions in the space being random so that the particles are arranged in a random spatial distribution, wherein repetition of the method permits the force impulse applied to particles at selected positions to be determined;
iii) step g) includes observing the motion of the particles as they move and determining any spatial dependence of the type of force impulse that has been applied to the particles, optionally or preferably a radial dependence of the force impulse;
iv) the desired control of the particles includes only moving a portion of the particles and rest of the particles remain stationary; and
v) the pre-determined acoustic field is formed as a vortex trap, optionally or preferably formed by an acoustic force field created by a Bessel function and step f) involves altering the pre-determined acoustic field so that only the particles held in the trap move and the rest of the particles remain stationary.

22. An apparatus according to claim 14, wherein the method includes calibrating the apparatus by:
i) selecting a pre-determined acoustic force field to be created to control movement of a particle in the space;
j) applying the pre-determined acoustic force field to hold the particle in a desired position in the space;
k) altering the pre-determined acoustic force field that is created to exert a force impulse for moving the particle along a path for a first set of acoustic wave generator time applied and maximum amplitude settings;
l) observing movement of the particle to determine the type of force impulse that has been applied to the particle; and
m) using steps k) and l) to calibrate the control device in controlling the acoustic wave generators to obtain the desired force impulse to be applied on the particles to acoustically control the particles; and
wherein the method further comprises calibrating the control device prior to performing the method to acoustically control the particles.

23. The method according to claim 22, further comprising:
performing a step a), b) and/or c) based on the determined calibration so that particles at different positions in the space experience different ones of the respective force impulse control modes a), b) and/or c); or
performing a step a), b) and/or c) based on the determined calibration so that only a single particle, or portion of the particles are moved by the applied force impulse control mode depending on the position(s) of the particle(s) as determined by the calibration method.

24. The method according to claim 1, wherein the method is a computer implemented method performed by a control device that is configured to receive instructions to perform the method which are stored on a computer readable medium.

25. A computer readable medium on which are stored instructions to perform the method of claim 1.
